(19) United States
(12) Patent Application Publication
(10) Pub. No.: US 2026/0278650 A1
(43) Pub. Date: Sep. 17, 2026

(54) MACHINE LEARNING-ENABLED FEEDBACK

(71) Applicant: CallMiner, Inc., Waltham, MA (US)

(72) Inventors: Jason A. McKay, Flint, TX (US); Douglas J. Sudd, Fort Myers, FL (US); Felix Lepa, Fort Myers, FL (US); Wyatt E. Baggett, Fort Myers, FL (US); Bruce K. McMahon, Lunenburg (CA)

(21) Appl. No.: 19/443,237

(22) Filed: Jan. 8, 2026

Related U.S. Application Data
(60) Provisional application No. 63/770,803, filed on Mar. 12, 2025.

(51) Int. Cl. G06Q 30/0282; G06N 20/00; G06Q 30/015

(52) U.S. Cl. CPC G06Q 30/0282; G06N 20/00; G06Q 30/015

(57) ABSTRACT

Methods disclosed herein include receiving a record of an interaction between an agent and a human participant in the interaction, analyzing the record to generate at least one characteristic of the interaction attributable to the human participant, wherein the characteristic comprises: a topic, a non-word symbol, metadata, a period of silence, a language characteristic, or an acoustic aspect, determining at least one category or score for at least a portion of the interaction based on the characteristic, generating a summary of the interaction using a machine learning model, and generating a customized communication based on the category or score, wherein the customized communication includes the summary and at least one prompt for the human participant.

### REFERENCE TO RELATED APPLICATIONS

This application claims the benefit of and priority to the following provisional application, which is hereby incorporated by reference in its entirety herein for all purposes: U.S. patent application Ser. No. 63/770,803 , entitled “MACHINE LEARNING-ENABLED CUSTOMER SURVEYS”, and filed Mar. 12, 2025 (Attorney Docket No. CALL-0009-P01).

U.S. Pat. No. 9,413,891 (the “891 Patent”), entitled “REAL-TIME CONVERSATIONAL ANALYTICS FACILITY”, filed Jan. 8, 2015, as U.S. patent application Ser. No. 14/592,510 (Attorney Docket No. CALL-0004-U01), and issued on Aug. 9, 2016, is incorporated by reference in its entirety herein for all purposes.

U.S. Patent Application Publication No. 20240144916 (the “916 Publication”), entitled “MACHINE LEARNING ENABLED CATEGORY CREATION”, filed Oct. 26, 2025, as U.S. patent application Ser. No. 18/384,228 (Attorney Docket No. CALL-0008-U01) and published on May 2, 2024, is incorporated by reference in its entirety herein for all purposes.

### BACKGROUND

Customer experience (CX) refers to the overall perception that a customer has of a company, which may be based on interactions they have with a company's brand and across various touchpoints throughout their journey. It may encompass every interaction, including pre-purchase interactions (e.g., marketing, advertising, browsing a website), the purchase process itself, and post-purchase interactions (e.g., customer support, product usage, returns).

CX is influenced by a wide range of factors, including the quality of products or services, the ease of doing business, the effectiveness of customer service, the consistency of messaging and branding, and the overall emotional impact of interactions. Positive CX leads to satisfied and loyal customers who are more likely to make repeat purchases, recommend the brand to others, and become brand advocates. On the other hand, negative CX can result in customer dissatisfaction, churn, and damage to the brand's reputation. In some examples, CX may be measured by understanding the interactions with contact center representatives (sales, customer support, etc.).

### SUMMARY

The disclosure herein relates to incorporating survey generation into the CX measurement process.

In some aspects, the techniques described herein relate to a method, including: receiving a record of an interaction between an agent and a human user in the interaction; analyzing the record to generate at least one characteristic of the interaction attributable to the human user, wherein the at least one characteristic includes: a non-word symbol, a period of silence, a language characteristic, or an acoustic aspect; determining at least one category or score for at least a portion of the interaction based on the at least one characteristic; generating a summary of the interaction using a machine learning model; and generating a customized communication based on the at least one category or score, wherein the customized communication includes the summary and at least one prompt for the human user.

In some aspects, the techniques described herein relate to a method, including: receiving a record of an interaction between an agent and a human participant in the interaction while the interaction is ongoing; analyzing the record to generate at least one characteristic of the interaction attributable to the human participant, wherein the at least one characteristic includes: a topic, a non-word symbol, metadata, a period of silence, a language characteristic, or an acoustic aspect; determining at least one category or score for at least a portion of the interaction based on the at least one characteristic; optionally, generating a summary of the interaction using a machine learning model; generating, based on the at least one category or score, survey questions about the interaction; and administering the survey questions to the human participant while the interaction is ongoing.

These and other systems, apparatus, methods, objects, features, and advantages of the present disclosure will be apparent to those skilled in the art from the following detailed description of the example embodiments and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts an example embodiment of a method of AI-enabled generation of post-interaction surveys.

FIG. 2 depicts an example embodiment of a method of AI-enabled generation of during-interaction surveys.

FIG. 3 depicts an example embodiment of an outreach engine architecture.

FIG. 4 depicts an example embodiment of an automated customer outreach workflow.

FIG. 5 depicts an example embodiment of a manual customer outreach workflow.

FIG. 6 depicts an example embodiment of a graphical user interface for managing distribution of a survey.

FIG. 7 depicts an example embodiment of a graphical user interface for managing distribution of a survey.

FIG. 8 depicts an example embodiment of a graphical user interface for managing distribution of a survey.

FIG. 9 depicts an example embodiment of a graphical user interface displaying a summary of a consumer interaction.

FIG. 10 depicts an example embodiment of an outreach landing page.

FIG. 11 depicts an example embodiment of an outreach landing page.

FIG. 12 depicts an example embodiment of an outreach landing page.

FIG. 13 depicts example email templates configurable by an administrator.

FIG. 14 depicts example email templates configurable by an administrator.

FIG. 15 depicts an example embodiment of a dashboard for presenting outreach scores.

FIG. 16 depicts an administrator view of a user interface that allows journey analysis and scoring.

FIG. 17 depicts an administrator view of a user interface that allows journey analysis and scoring.

FIG. 18 illustrates an example graphical user interface displaying an email delivered to an administrator or other user.

FIG. 19 depicts an example embodiment of a Net Promoter Score.

FIG. 20 depicts an example embodiment of a Customer Satisfaction score.

FIG. 21 depicts an example embodiment of a Customer Effort Score (CES).

FIG. 22 depicts an example embodiment of a user interface displaying contact reasons.

FIG. 23 depicts an example embodiment of an outreach landing page.

### DETAILED DESCRIPTION

Customer experience (CX) is measured using a variety of qualitative and quantitative methods to capture a holistic view of how customers perceive and interact with a company's products, services, and overall brand. Indeed, there are a number of methods and metrics used to measure CX.

These methods and metrics may include surveys and feedback forms, such as may provided in metric form by a Net Promoter Score (NPS), and which may measure customer loyalty by asking how likely customers are to recommend the company to others on a scale of 0 to 1. NPS may effectively measure an overall relationship a company has with their customers.

These methods and metrics may include Customer Satisfaction (CSAT), which may be measured with a specific interaction and/or overall experience, usually through a simple question like “How satisfied were you with your experience?” CSAT effectively gauges how happy a customer is with either a specific interaction or their general experience with an organization such as a company. (For convenience herein, like terms such as “company,” “business,” and “organization” may be used interchangeably.)

These methods and metrics may include a Customer Effort Score (CES), which may measure the ease of interaction with the company by asking customers how much effort they had to exert to get their issue resolved. CES may effectively measure how effortless (or “effort-full”) it is for a customer to interact with the company.

These methods and metrics may include customer support metrics. Customer support metrics may include, for example, first response time—the time it takes for a customer service team to respond to a customer query; resolution time—the time it takes to resolve a customer issue from initial contact; and/or ticket volume—the number of customer service requests received and handled over a period.

These methods and metrics may include a customer journey mapping, which may include, for example, analyzing the steps a customer takes from initial contact to final purchase and beyond (e.g., technical support), identifying pain points and moments of delight.

These methods and metrics may include a customer churn rate, which may, for example, include measuring the rate at which customers stop doing business with a company, and/or analyzing patterns and reasons for churn to improve retention strategies.

These methods and metrics may include a Customer Lifetime Value (CLV), which may, for example, include calculating the total revenue a company can expect from a single customer account over the entire relationship, and/or using CLV to understand the long-term value of customer relationships and make strategic decisions.

These methods and metrics may include a Voice of the Customer (VoC) Program(s), which may, for example, implement systematic processes to collect, analyze, and act on customer feedback, and/or may use tools like feedback management systems and customer panels to gather insights.

These methods and metrics may include customer reviews and ratings, which may include, for example, collecting and analyzing reviews on third party platforms, such as Google, Yelp, and/or industry-specific sites, and/or monitoring ratings on e-commerce platforms, app stores, and/or social media.

These methods and metrics may include social media monitoring, which may, for example, include monitoring tracking, mentions, comments, and/or direct messages on social media platforms; and/or analyzing sentiment and engagement metrics to gauge public perception.

These methods and metrics may include behavioral analytics, such as, for example, tracking and analyzing customer behavior on websites and apps, such as click-through rates, bounce rates, and/or time spent on pages, and/or monitoring usage patterns, purchase history, and/or service interactions.

These methods and metrics may include usability testing, such as, for example, conducting tests with real users to observe how they interact with products or services, and/or gathering qualitative feedback on user experience.

These methods and metrics may include focus groups and interviews, which may, for example, include conducting in-depth interviews and focus groups to gather detailed qualitative insights, and/or understanding customer needs, preferences, and pain points through direct conversations.

By combining these methods and/or metrics, companies may gain a comprehensive understanding of their customers' experiences, identify areas for improvement, and enhance overall customer satisfaction and loyalty. Any and/or all of these measures and metrics for CX may be incorporated into example embodiments herein, such as in survey generation and other mechanisms for customer outreach.

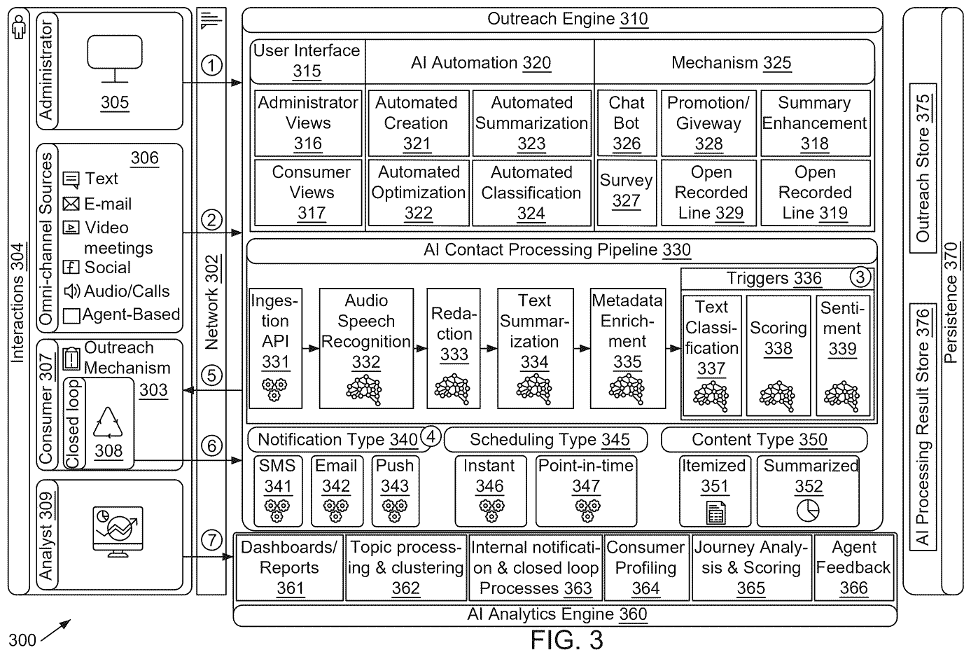

Systems and methods according to example embodiments disclosed herein, such as according to the example architecture depicted in FIG. 3, may provide outreach initiatives including customer data, user data, artificial intelligence (AI) survey generation, enhanced scoring and trending, and feedback follow-up. For example, customer outreach may include the ability to send summaries and follow-up items to consumers (which may be referred to herein interchangeably as customers or, in some contexts, users, and which may refer to a human that receives service from a company, such as in the context of customer service) to drive next steps in the process. Consumer data may provide example systems and methods with the ability to understand various data points that relate to a specific consumer (email address, phone numbers, social media handles, gender, age bracket, location, etc.). AI survey generation may provide the ability to send a NPS, CSAT, CES, and/or other CX survey, which in an example may be powered by large language model (LLM) (e.g., generative pre-trained transformer (GPT)) prompts (e.g., be “AI-generated”). Enhanced scoring and trending may provide example systems and methods with the ability to score a consumer's overall interaction with a company to predict NPS, churn risk, etc.—for example, customer journey scoring and summarization may provide a single score and summary of the entire path of a consumer; journey path analysis may look at the most common paths a customer takes in their journey and compare to other user profiles; and/or a contact profile may understand the “DNA” of a contact to determine what events lead to the best outcomes. Feedback follow-up may provide the ability to respond to notifications regarding customer surveys, difficult interactions, and/or feedback sessions with real-time guidance and tracking.

For example, disclosed herein are systems and methods to incorporate survey generation into the CX measurement process. Disclosed herein is AI survey generation as well as feedback follow-up, which may provide the ability to respond to notifications regarding customer surveys.

AI-generated surveys may be used to gather data about a consumer experience, and responses may be used to reach out to consumers as appropriate for follow-up. Additionally, an AI-generated summary of a consumer interaction may be generated, such as for presentation to the consumer. Disclosed herein are systems and methods for generating post-interaction surveys, or during-interaction surveys, that are customized based on aspects of the interaction and include an AI-enabled interaction summary.

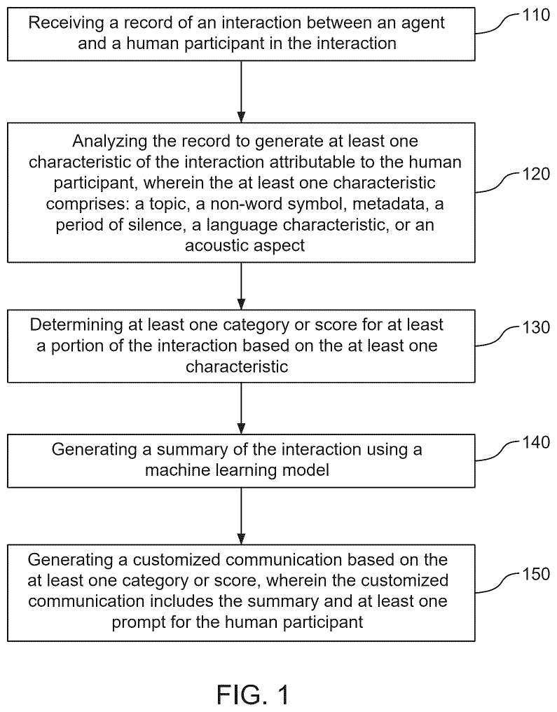

Referring now to FIG. 1, disclosed herein are example systems and methods of generating post-interaction surveys. For example, at step 110, a record of an interaction between an agent, either an automated or a human agent, and a human participant in the interaction (e.g., a customer) may be received (e.g., via one or more of the omni-channel sources 306 described by example with reference to FIG. 3). At step 120, the record may be analyzed to generate at least one characteristic of the interaction attributable to the human participant, such as by using the methods and systems disclosed in the 891 Patent and the 916 Publication. In an example, this analysis may be performed by an AI contact processing pipeline 330, as described by example with reference to FIG. 3. For example, the record may be provided over network 302 to ingestion application programming interface (API) of the AI contact processing pipeline 330 and the record may be subsequently analyzed—such as by audition speech recognition 332, text summarization 334, metadata enrichment 335, text classification 337, scoring 338, and/or sentiment 339—to discern the at least one characteristic of the record. The characteristic can be a topic, a non-word symbol, metadata, a period of silence, a language characteristic, or an acoustic aspect. The interaction that is analyzed may be a social media interaction, a review post, an IVR, a chat, an email, audio, a call, a voicemail, a message, a blog post, a survey, a video conference, an online meeting, or a webinar, although embodiments are not limited thereto. In example embodiments, the text classification 337 may generate text classification as part of the architecture 300 for general analytics use cases. In example embodiments, automated classification 324 may consume the output from text classification 337 for triggering when to send an outreach.

At step 130, based on the at least one characteristic, at least one category or score (e.g., an interaction score) for at least a portion of the interaction can be generated, such as by using the methods and systems disclosed in the 891 Patent and the 916 Publication and/or according to CX measurements and metrics as described by example herein. In the example, the at least one category can be a behavior, a sentiment, a reason, a procedure, a competitor, a dissatisfaction, an empathy, a repeat contact, a transferred call and/or a politeness. In the example, the interaction score may further be based on at least one acoustic, prosodic, syntactic, or visual feature of the interaction. In an example, the interaction score may be calculated by the AI contact processing pipeline 330, such as scoring element 338 (which may also include a trigger, as described by example herein).

At step 140, machine learning models, such as an extractive machine learning summarization model or an abstractive machine learning summarization model, may be used to generate a summary of the interaction. In an example, this summary may be generated by text summarization 334 of the architecture 300 shown in FIG. 3. In some aspects, the abstractive machine learning summarization model is trained based on long form summarization, chunked/bucketed summarization, or an interaction summary label/short sentence. The extractive machine learning summarization model may be configured through training to identify at least one word or phrase from the record, the at least one word or phrase corresponding to the summary of the interaction. Training may be based on supervised learning for two-class labels, wherein the first label may be for summary content and the second label may be for non-summary content.

In some examples, step 120, step 130, and/or step 140 may be performed by the AI contact processing pipeline 330 described by example herein with reference to FIG. 3, which may include the model(s) used to generate the summary, and/or which may rely on AI automation 320 such as automated summarization 323. As an example, text summarization 334 may be used to generate the summary of the interaction, and may include a machine learning model as may be described by example herein.

Continuing with the example of FIG. 1, at step 150, a customized communication may be generated based on the at least one category or score, where the customized communication may include the summary and at least one prompt for the human participant (e.g., as part of a mechanism 325 such as a survey 327), and which may be transmitted to the human participant (e.g., consumer 307), examples of which are described herein (e.g., via an outreach mechanism 303 such as an outreach landing page). The at least one prompt may be and/or be included in at least one of a survey 327 or an open-ended response field (which in some examples may also be part of a survey, although embodiments are not limited thereto). As discussed herein, in an example, the prompt may be generated by automated creation 321.

In an example, the customized communication may include a promotion/giveaway 328 such as at least one of an offer, a delivery of resources or information, a coupon, a call, or other customized customer engagement. In some examples, as described with reference to FIG. 3, the customized communication may correspond to a mechanism 325, as may be indicated and/or created by an administrator 305 (which may, in examples, include a human user of the organization). Furthermore, in some examples, the customized communication may be generated based on, e.g., the at least one category or score from the interaction triggering a trigger 336. For example, a low consumer satisfaction score may trigger the scoring trigger 338, prompting automatic sending of the customized communication.

In an example where the customized communication (e.g., a mechanism 325) includes a survey 327, the survey may be at least one of a Net Promoter Score (NPS) survey, a Customer Satisfaction Score (CSAT) survey, a Customer Effort Score (CES) survey, open-ended including voice/text/symbols, multiple choice, multi-select, an IVR survey, a market research survey, a market segmentation survey, a brand perception survey, a product feedback survey, an employee satisfaction survey, an event feedback survey, or a website/user experience (UX) survey.

In an example where the customized communication includes a survey, the survey may be of various types depending, e.g., on objectives and information an organization such as a company wants to gather. Some types of surveys include customer experience surveys (e.g., customer satisfaction surveys, net promotor score surveys, customer effort surveys), market/brand perception surveys (e.g., market research surveys, market segmentation surveys, brand perception surveys), product enhancement surveys (e.g., product feedback surveys), employee experience surveys (e.g., employee satisfaction surveys), and miscellaneous surveys (e.g., event feedback surveys, website/user experience (UX) surveys). In an example, the type of survey for a customer may be grouped according to the various points in a customer's journey. For example, customer satisfaction surveys may be provided to a customer after being provided with customer service, as may be described by example herein.

In some embodiments, the at least one prompt is at least partially populated, such as by automated creation 321, where populating the at least one prompt includes: populating at least one input field of the at least one prompt with answers corresponding to a question associated with the at least one input field using a form filling model (e.g., a natural language processing (NLP) model), where the form filling model is configured through training to identify an answer to the question associated with the at least one input field from at least one of the record of the interaction or the interaction summary. The form filling model may include a plurality of models with at least one model for each question associated with an input field of the at least one prompt. In one example, the form filling model is based on a clustering algorithm, and each input field is represented by at least one cluster. In another example, the form filling model identifies the answer by clustering content from the record. In another example, the form filling model identifies the answer by further determining the at least one input field for the content based on a cluster of the content. In some examples, the form filing model may be included as part of the outreach engine architecture 300 described by example with reference to FIG. 3, for example, as part of the AI automation 320 such as automated creation 321.

In some embodiments, analytics are performed on a text or recognized voice/spoken words in the open-ended response field, including determining at least one category or score based on a content of the open-ended response, the content including at least one of written text, audio speech, non-word symbols, metadata, silences, language characteristics, or acoustic characteristics.

In some embodiments, one or more rules may be applied to delivery including at least one of delivering the customized communication by a specified delivery type, restricting delivery (e.g., a scheduling type 345 in FIG. 3) to a timeframe (having an “active period” for when to send, schedule an occurrence (delay in sending), cool off periods (no communications after one has been sent)), restricting delivery by a frequency, restricting delivery to a number of identified consumers per a time period, or restricting delivery in response to an event, factor, or other data. For example, the method may include restricting at least one of partially customizing the customized communication or delivery in accordance with one or more rules. The one or more rules may include restricting subsequent communication of a survey when the interaction was a survey; restricting a communication when the interaction occurred more than a predetermined time in the past; prioritizing delivery of a communication from a plurality of generated communications based on an aspect of the interaction, user data, metadata, or customer journey data; or combining one or more communications from a plurality of generated communications based on an aspect of the interaction, user data, metadata, or customer journey data.

In embodiments, the customized communication and any responses to the customized communication may be included in a customer journey, where the customer journey includes linking one or more communications on at least one communication channel of a plurality of communication channels to the customer. At least one of the record, the at least one characteristic, the at least one category or score, the summary, the customized communication, one or more responses to the customized communication, analytics on the one or more responses to the customized communication (e.g., via AI analytics engine 360), or the at least one category or score based on the one or more responses to the customized communication may be selectable from an outreach dashboard user interface (UI) (e.g., a user interface 315 of FIG. 3), the outreach dashboard UI depicting interactions over time. The outreach dashboard UI may further depict survey content topics and sentiments that get consolidated into a journey view, outreach attempts, response rates, survey calculations (NPS, CSAT, CES, etc.), demographic data (based on metadata such as email address, phone numbers, contact information, social media handles, gender, age bracket, name, or location), or user data. User data may include preferences and interests (user preferences related to content, products, services, and interaction styles), one or more of behavioral data (information on how a user interacts with the company, including survey responsiveness, purchases, and contact frequency, history and activity (records of past interactions, transactions, and engagements within the application or service), settings and configurations (custom settings the user has chosen, such as notification preferences, privacy settings, and display preferences), authentication information (credentials like usernames, passwords, and security questions used for identity verification), or demographic information (broader details like location, occupation, and education level, often used for targeted services and marketing).

In some embodiments, the record may be redacted (e.g., via redaction 333 of FIG. 3) before generating the summary of the interaction (e.g., via text summarization 334 of FIG. 3). In some embodiments, the summary of the interaction may be enriched with metadata (e.g., via metadata enrichment 335 of FIG. 3).

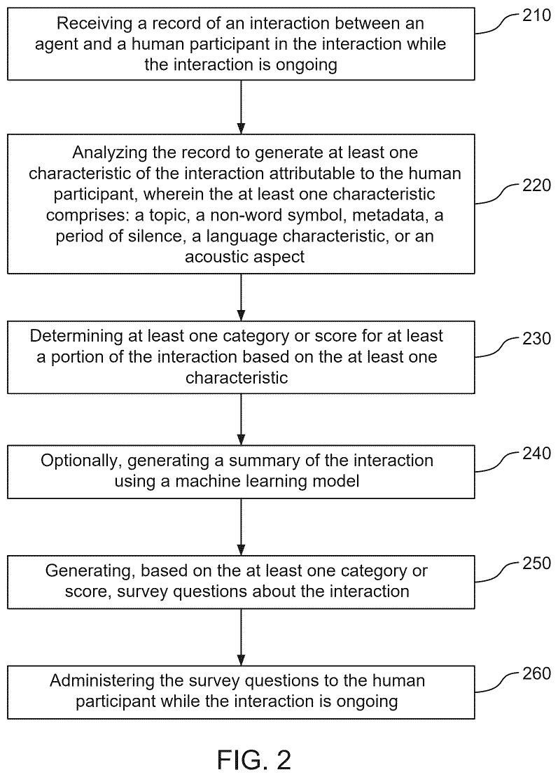

Referring now to FIG. 2, disclosed herein are systems and methods of generating during-interaction surveys. For example, at step 210, a record of an interaction between an agent (e.g., human or automated) and a human participant in the interaction may be received while the interaction is ongoing (e.g., via one or more omni-channel sources 306 of FIG. 3) and, at step 220, the record may be analyzed to generate at least one characteristic of the interaction attributable to the human participant, where the at least one characteristic may be as described by example elsewhere herein. Furthermore, example interaction types are described herein. At step 230, at least one category or score, each as described herein, may be determined for at least a portion of the interaction based on the at least one characteristic. Optionally, at step 240, a summary of the interaction may be generated using the machine learning model described herein. At step 250, based on the at least one category or score, survey questions about the interaction may be generated. The example may include, at step 260, administering the survey questions to the human participant while the interaction is ongoing, such as by a same or different channel as the interaction.

In embodiments, the example includes recording the human participant's answers to the survey questions, and generating a summary of the interaction and responses to the survey questions. The survey questions may be part of a survey, as described herein. Responses to the survey questions may be included in a customer journey, where the customer journey includes linking one or more communications on at least one communication channel of a plurality of communication channels to the customer.

At least one of the record, the at least one characteristic, the at least one category or score, the summary, the survey questions, one or more responses to the survey questions, analytics on the one or more responses to the survey questions, or the at least one category or score based on the one or more responses to the survey questions may be selectable from an outreach dashboard user interface (UI), the outreach dashboard UI depicting interactions over time and as otherwise described herein.

In some embodiments, the record may be redacted before generating the summary of the interaction. In some embodiments, the summary of the interaction may be enriched with metadata.

In some aspects, the method may further include performing analytics on a text or recognized voice/spoken words in response to the survey questions (e.g., via the AI pipeline 330 of FIG. 3), where the analytics includes determining at least one category or score based on a content of the response, the content including at least one of written text, audio speech, non-word symbols, metadata, silences, language characteristics, or acoustic characteristics. For example, category or score may be determined by text classification 337 and scoring 338, respectively (e.g., for triggering).

FIG. 3 depicts an outreach engine architecture 300 according to example embodiments of the present disclosure. The various elements of the outreach engine architecture, which may be represented by the blocks and/or other delineations of FIG. 3, may each include software and/or hardware components as may be described by example herein. While certain elements are shown by example in the block diagram of the architecture 300 in FIG. 3, other elements may exist in the architecture 300 in accordance with example embodiments disclosed herein.

In example embodiments, the outreach engine architecture 300 may include an outreach engine 310 including a user interface 315 (e.g., with administrator views 316 or consumer views 317), AI automation 320, mechanism 325, an AI contact processing pipeline 330, a notification type 340, a scheduling type 345, a content type 350, and an AI analytics engine 360. In example embodiments, the outreach engine architecture 300 may also include a network 302, interactions 304, outreach store 375, AI processing result store 376, and persistence 370.

In example embodiments, the outreach engine 310 may communicate with interactions 304 via network 302 (which may, in some examples, include one or more networks including a wide area network (WAN), local area network (LAN), the Internet, etc.). The interconnection and interfacing of these elements (e.g., between the elements including the outreach engine 310 having, among other elements, user interface(s) 315, AI automation 320 (including automated creation 321 of mechanisms 325, automated optimization 322 of mechanisms 325, automated classification 324, and automated summarization 323), mechanism(s) 325, AI contact processing pipeline 330, notification type(s) 340, scheduling type(s) 345, and/or content type(s) 350; AI analytics engine 360; persistence 370; and interactions 304, may provide the outreach engine architecture 300 that automates the generation and providing of surveys and other outreach mechanisms tailored to a specific human, such as a customer, as based on CX, the at least one category or score for the customer interaction(s) as described by example herein, and/or on, e.g., mechanisms, types, and triggers configured by an administrator 305, to provide technical improvements to automated, customer-specific outreach and analytics thereof. For example, technical improvements may include the ability to convert, e.g., spoken and/or written voice of a customer (in both real-time and post-contact contexts) into an action that results in an automated outreach through a unified architecture 300. Additionally, the architecture 300 according to example embodiments may consume the results of outreaches and turn them into actional intelligence and insights that are relevant to a company and/or customer.

In an example operation of the outreach engine architecture 300, and with reference to the circled numbers 1-7 of FIG. 3, (1) an administrator 305 (e.g., a human user, who may have administrative access to the outreach engine architecture 300) may interact with the outreach engine 310 (e.g., using the user interface 315, which in examples may include a plurality of user interfaces) to configure a mechanism 325 (e.g., a chat bot 326, survey 327, promotion/giveaway 328, open recorded line 329 or 319, or summary enhancement 318), scheduling type 345 (e.g., instant 346 or a point-in-time 347), content type 350 (e.g., itemized 351 or summarized 352), and/or notification type 340 (e.g., SMS text 341, email 342, push notification 343, a third party messaging application (e.g., WeeChat, WhatsApp, etc.). The outreach engine architecture 300 may be configured to send the mechanism 325, such as SMS text 341, email 342, push notification 343, and/or a third party messaging app message, to the customer. Additional notification types 340 may include providing a software development kit (“SDK”) for mobile apps (e.g., IOS, Android, Flutter, React Native) that may be used by entities that provide their own mobile apps. In an example, an SDK may permit a company to configure and send, e.g., push-based notifications 343 through the company's mobile app.

Then, continuing with the example operation, (2) an omni-channel source 306 (e.g., with channels including all or some of text, email, video meeting, social media, audio/calls, and/or agent-based (e.g., from chats, surveys, etc.) may interact with an ingestion application programming interface (API) 331 of the AI contact processing pipeline 330 to send data to the AI contact processing pipeline 330. In some examples, the data may be processed by the AI contact processing pipeline 330 using audio speech recognition 332, redaction 333 (e.g., of sensitive information such as personally identifiable information or expletives), text summarization 334, and/or metadata enrichment 335. For example, as described with reference to example embodiments herein, text summarization 334 may provide a summary of the interaction. Redaction 333 may remove sensitive aspects of the consumer data. Audio speech recognition 332 may recognize and transcribe voice when the omni-channel source 306 includes audio such as a call.

By providing consumer input to the outreach engine 310 through the ingestion API and subsequent pipeline processing (e.g., speech recognition 332, redaction 333, text summarization 334, and/or metadata enrichment 335) prior to the triggers 336 discussed by example herein, example embodiments may provide technical improvements to the field of automated outreach by vastly simplifying the amount of information in a format more easily matched to triggering conditions for sending said outreach. Additionally, such a pipeline 330 may provide the information relevant to automatically creating (e.g., via an AI model by automated creation 321) prompts to be included in the customer outreach, including, for example, a survey or open-ended response. In some examples, automated optimization 322 may be provided, which may be a component of automated creation including learned outputs from customer information profiles, relevant business metric, key performance indicator (KPI) trends, such a using an AI toolset, to generate outreach in a simplified manner.

Then, (3) such data may be processed by triggers 336 (e.g., text classification triggers 337, scoring triggers 338, and/or sentiment triggers 339) in the AI contact processing pipeline 330 to determine if the outreach engine 310 will send a configured mechanism 325 to the consumer 307. As an example, such triggers 336 may include triggers based on categorization and/or score, as described with reference to example embodiments herein.

Then, in example embodiments, a notification may be sent to the consumer 307 (e.g., via a user interface 315, such as a consumer view 317, and/or SMS, email, push notification, third party messaging app, and/or other notification type 340 as described by example herein) when one or more of the trigger(s) 336 is triggered by the data. Such a notification may reference and/or be based on the mechanism 325, scheduling type 345, content type 350, and/or notification type 340, as may be configured by an administrator. As an example, the notification may include and/or provide access to the mechanism 325 (e.g., via a hyperlink), which may be a customized communication such as a survey and/or an open-ended response field, and which may include at least one prompt generated by a form filling model (e.g., as part of AI automation 320), as described by example herein. By involving a customized communication (e.g., using a trained model) to obtain consumer feedback, a consumer may be more likely to provide a full and accurate response to the architecture 300.

Then, in (5), the consumer may complete an outreach mechanism 303, which may be based on the configuration of the administrator 305. In an example, the outreach mechanism 303 may be or be provided via an outreach landing page, as may be discussed by example herein, and which may also be referred to herein as a survey landing page, a consumer landing page, and/or a customer landing page. The consumer may complete the outreach mechanism 303 (e.g., complete a survey provided via the outreach mechanism) via a user interface, which in an example may be provided by a consumer view 317.

Then, (6) once the consumer completes the outreach mechanism 303, the outreach mechanism 303 may be submitted to the AI contact processing pipeline 330 to form a closed feedback loop 308. The AI contact processing pipeline 330 may digest the feedback from the consumer and AI analytics engine 360 may provide analysis thereto. At (7), an analyst 309 may review analyst reviews results of the outreach engine 310, including leveraging features within the AI analytics engine 360, such as dashboards/reports 361, topic processing and clustering 362, internal notifications and closed loop processes 363, consumer profiling 364, journey analysis and scoring 365, and/or agent feedback 366, as may be described by example herein.

In example embodiments, the survey 327 may be automatically customized based on information from the AI contact processing pipeline 330 and provided to the consumer 307 via an outreach mechanism 303. For example, as described herein, automated creation 321 may generate prompts for a survey 327 based on information gathered about the user and their customer experience. In example embodiments, AI contact processing pipeline 330 may automatically identify and analyze each recorded interaction between the consumer and service to trigger and customize a follow-up survey therefrom. In example embodiments, consumer responses to an outreach mechanism 303 may be provided to the AI contact processing pipeline 330 for digestion.

Also, with reference to FIG. 3, the architecture 300 may include persistence 370, which includes data storage including an AI processing result store 376 and/or an outreach store 375. The AI processing result store 376 and outreach store 375 may provide two different locations to store data. Outreach store 375 may provide a location for storing outreach itself, and AI processing result store 376 may provide a location for storing anything supporting, e.g., AI tooling.

The architecture 300 according to example embodiments may provide an improved approach to customer engagement platforms through, e.g., a combination of services and methods as described by example herein. For example, first, the AI contact processing pipeline 330 may serve as a content processing workflow that analyzes and identifies areas of business value within the content that it processes. In examples, the content may be comprised of one or more of the omni-channel sources 306 as described by example herein. And, second, the outreach engine 310 of example embodiments may serve as an outreach processing framework that provides a way for companies to configure, e.g., different types of emails and SMS text communications to be sent to a customer. Thus, example embodiments may provide a mechanism for identifying areas of business value with content and pair that mechanism with a framework for giving companies a powerful and automated/autonomous way to engage the customers of a company.

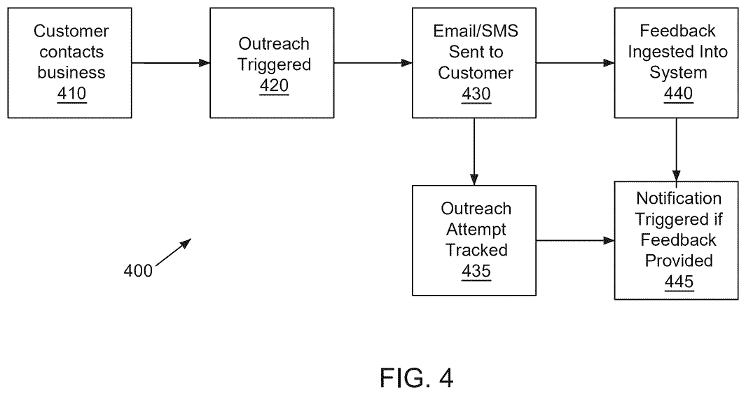

With reference to FIG. 4, in example embodiments, an automated customer outreach workflow 400 may include a step of a customer contacting 410 a business—for example, via at least one of the omni-channel sources 306 described by example with reference to FIG. 3. In an example, this contact may be provided to the outreach engine 310 through an ingestion API 331 and processed via the AI contact processing pipeline 330 including elements therein. If any, some, and/or all of the triggers 336 are triggered by the contact (e.g., according to its text classification 337, scoring 338, and/or sentiment 339), outreach to the customer may be triggered 420. Accordingly, in an example, an email, SMS, and/or push notification may be sent 430 to the customer (e.g., in accordance with the notification type 340). This outreach attempt may be tracked 435 and, if the consumer provides feedback, such as via an outreach mechanism 303, such feedback may be ingested 440 into the system (e.g., by the AI contact processing pipeline 330 and/or other structures of the architecture 300), and a notification may be triggered 445 that such feedback was provided.

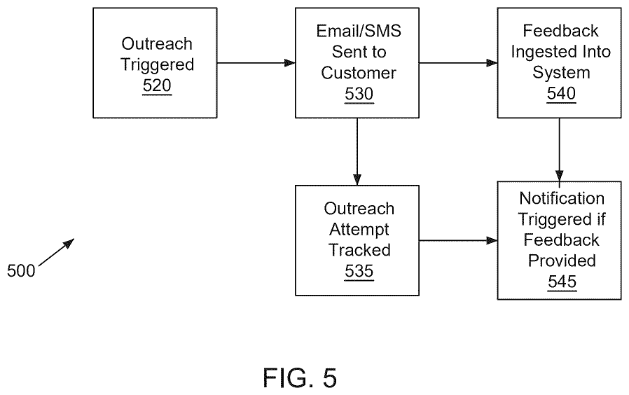

With reference to FIG. 5, in example embodiments, a manual customer outreach workflow 500 may include, e.g., manually triggering (e.g., by a user) outreach 520 to a consumer. Then, similar to the examples described with reference to FIG. 4, an email, SMS, and/or push notification may be sent 530 to the customer (e.g., in accordance with the notification type 340). This outreach attempt may be tracked 535 and, if the consumer provides feedback, such as via an outreach mechanism 303, such feedback may be ingested 540 into the system, and a notification may be triggered 545 that such feedback was provided.

With reference again to FIG. 3, the outreach engine architecture 300 according to example embodiments may provide an administrator 305 with the ability to customize an email template (e.g., for an email 342) sent to a consumer. This customization may be made via an administrator view 316 in a user interface 315. Additionally, an administrator 305 may be able to configure the sending requirements for an email 342 (including, e.g., scheduling type 345 and/or content type 350). Likewise, an administrator 305 may similarly configure the sending requirements for other notification types 340.

Furthermore, the outreach engine architecture 300 according to example embodiments may provide an administrator 305 with the ability to create a survey, such as a type of survey. Options may include creating a survey according to a prebuilt template (e.g., according to different types of surveys, as described by example herein), and/or creating a survey with AI elements (e.g., including prompts that may be automatically created by AI automation 320 as discussed by example herein). In examples, an AI component of the outreach engine architecture 300 may assist an administrator 305 with building the survey.

In some embodiments, the outreach engine architecture 300 may provide a survey landing page, which may serve as an outreach mechanism 303 and may provide a page for consumers to leave feedback based on/via the selected survey from survey creation. For example, the consumer 307 may be provided, via a consumer view of user interface 315, with a survey landing page and be presented with a survey therein. The survey landing page may be customized based on the selected survey, may provide the consumer with the ability to see summaries of surveys they've completed, and/or may include formatting for mobile devices.

In example embodiments, the outreach engine architecture 300 may provide dashboard data (e.g., via dashboards/reports 361 of the AI analytics engine 360). Such data may be displayed in a dashboard template, e.g., as displayed in an administrator view 316 of user interface 315. Such data may include data tracking the sent surveys, responses to surveys, calculation of scores (NPS, CSAT, CES, etc.), etc. However, embodiments are not limited thereto, and in some embodiments, a consumer 307 may be provided with dashboard data.

As discussed by example with reference to FIG. 3, example embodiments may provide the ability to send outreach messages based on specific scenarios. For example, an administrator 305 may be able to select a delivery type (e.g., notification type 30), such as email or SMS; the ability to set timing options (e.g., scheduling type 345), such as every Xth occurrence, and/or every X days/months, where X is a variable set by the administrator; the ability to set sampling options (e.g., every Xth consumer); and/or the ability to set priority options, such as “do not send outreach A if outreach B is also sent.”

Example embodiments may provide the ability to send different types of outreach messages (e.g., notification types 340) based on specific scenarios, and may include an AI-generated summary of the consumer's contact (e.g., from text summarization 334) as part of the outreach, either via the notification and/or in an outreach mechanism 303 such as an outreach landing page. An outreach landing page may provide the ability to gather feedback in a simplified user interface. Outreach templates may be edited and saved for, e.g., email and SMS—for example, the message body may be edited, the email address sender may be changed, custom branding may be added, a summary may be included, and an “opt out” option may be included. Example embodiments may include outreach tracking such as ingestion of sent outreach and responses, the ability to see outreach in a customer's journey, and/or tracking based on sent rate, response rate, etc. In examples, all outreach, outreach responses, tracking, and other data of the architecture 300 may be stored in persistence 370.

Example embodiments may expand outreach to be more customized to different customer needs. For example, AI-generated prompts for a mechanism 325 (e.g., a survey 327 or chat bot 326) may be customer-specific, bringing in specific details of the customer based on their profile and/or what is known about their customer experience. Notification types 340 may include SMS 341, email 342, and/or push notifications 343, but embodiments are not limited thereto, and in some examples, notification types may include, for example, notifications (such as messages) via third party applications, such as social media or social messaging applications (e.g., WhatsApp). Example embodiments may also generate unique uniform resource locators (URLs) for the outreach mechanism 303 such as a customer landing page.

In example embodiments, triggers 336, notification type 340, scheduling type 345, and content type 350 may provide mechanisms enabling the architecture 300 to provide a company with a self-service outreach system satisfying a wide array of business use cases.

In example embodiments, interactions 304, consumer 307, closed loop 308, outreach mechanism 303, outreach engine 310, AI contact processing pipeline 330, consumer profiling 364, and journey & analysis scoring 365 may enable a feedback loop. For example, (i) interaction may be ingested into the architecture (e.g., by 304, 306, 302, 331); (ii) the interaction may be processed by AI contact processing pipeline 330; (iii) a trigger may be generated based on the processing by the pipeline 330; (vi) an outreach may be sent on trigger generation (e.g., by 336, 340, 345, and 350); and (v) a result of the outreach is ingested into the architecture 300, thus “closing the loop” 308 (e.g., by a customer responding to a survey). In examples, consumer profiling 364 and journey & analysis scoring 365 may be mechanisms that are used by outreach engine 310 and AI contact processing pipeline 330 to make decisions about the target of an outreach. Such decisions may be used to customize the content being sent to the customer.

In example embodiments, automated summarization 323 may be utilized to distill lengthy sections of content or sentiment within an outreach survey. Automated classification 3244 may provide a mechanism for clustering concepts contained within a set of survey responses, in order to provide a company with key concepts contained in the response set.

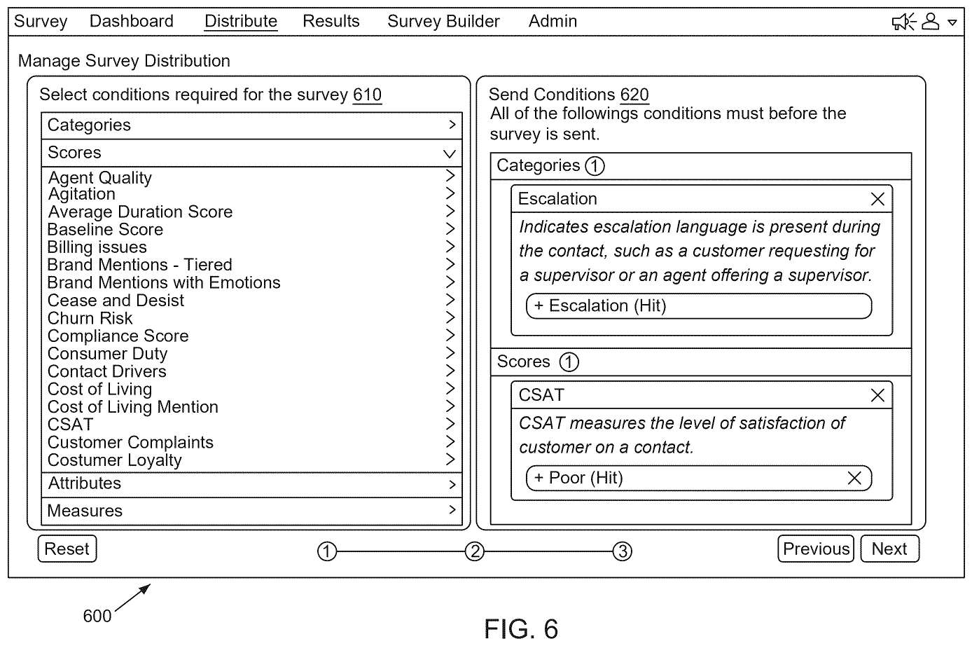

FIG. 6 illustrates an example graphical user interface 600 (e.g., displayed via a user interface 315) for managing distribution of a mechanism 325 such as a survey. Distribution management may include a window 610 for selecting conditions (e.g., triggers 336) required to trigger the survey, and/or a window 620 for setting specifics of those sending conditions—e.g., related to escalating language and/or CSAT score for a consumer.

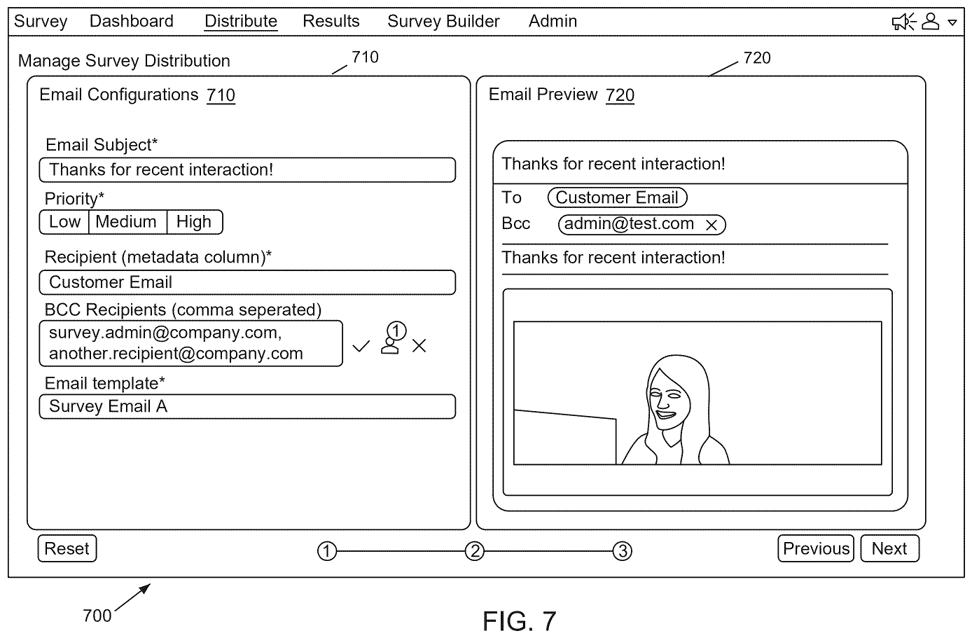

FIG. 7 illustrates an example graphical user interface 700 (e.g., displayed via a user interface 315) for managing distribution of a mechanism 325 such as a survey, including a window 710 for setting email configurations for an email 342 notification type 340. Additionally, the interface 700 may include a preview 720 of the email to be sent to the consumer.

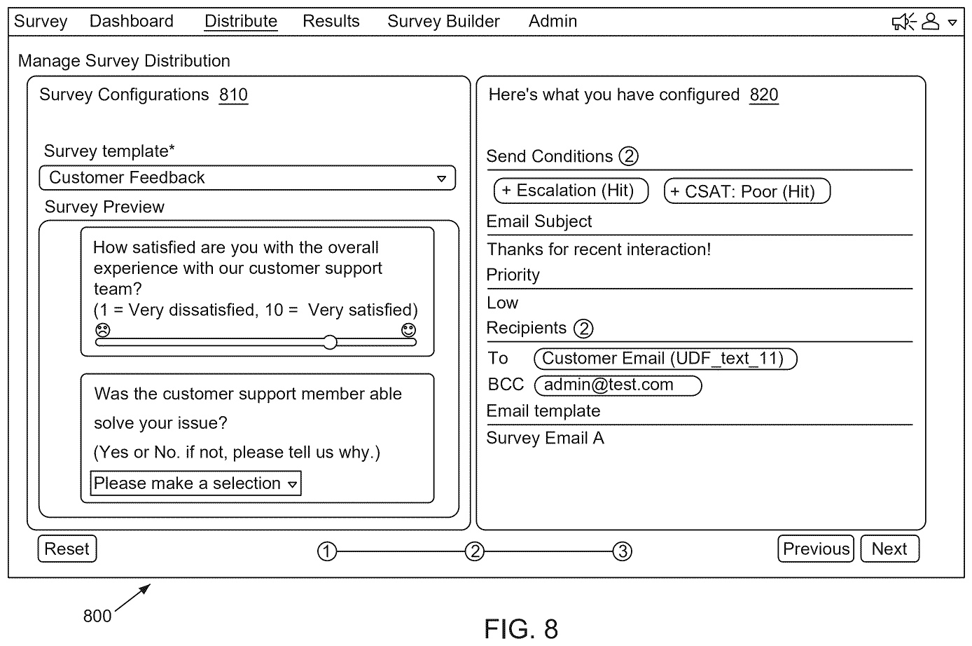

FIG. 8 illustrates an example graphical user interface 800 (e.g., displayed via a user interface 315) for managing distribution of a mechanism 325 such as a survey, including a window 810 for setting configurations of the survey (e.g., a template for the survey, such as a “Customer Feedback” template), and/or a window 820 for displaying the set configurations. In some embodiments, survey configurations may include an indication of a customized communication (e.g., a prompt) generated according to example embodiments herein, such as using or based on a machine learning model. The indication may include the location of the prompt in the survey, what data the prompt will be based on, the type of question to be asked by the prompt, etc.

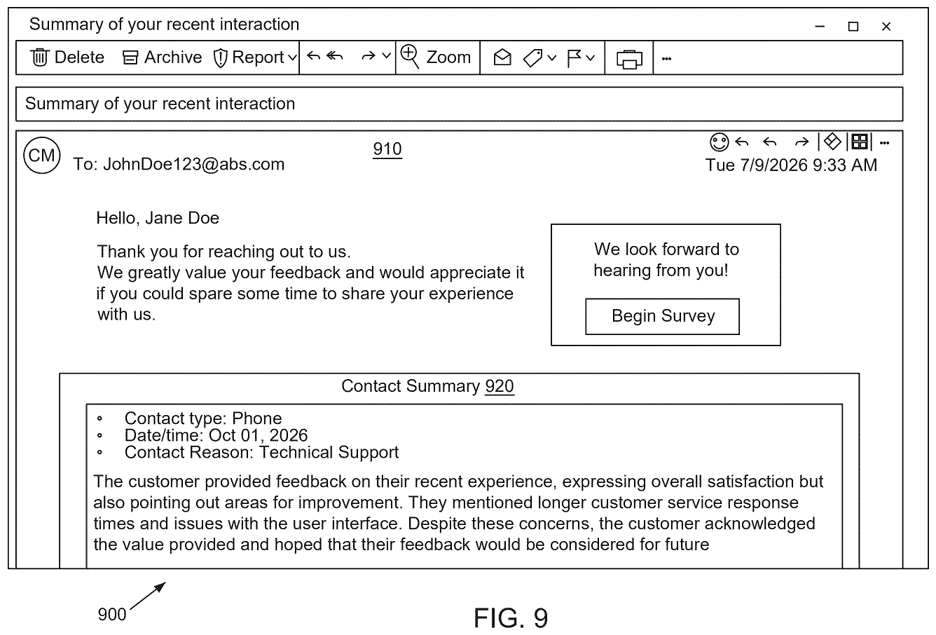

FIG. 9 illustrates an example graphical user interface 900 (e.g., displayed to an administrator, such as via a user interface 315) displaying an email 910 notification sent to the consumer as well as a contact summary 920 providing survey feedback from the consumer (for example, in the form of a summary of contact with the consumer, as may be provided by architecture 300 herein).

In some embodiments, outreach engine architecture 300 may provide an outreach landing page as an outreach mechanism 303 (for example, provided via or after a notification is sent to the consumer per notification type 340). In an example, the outreach landing page may provide a summary of events, next actions, gather feedback (e.g., via a customized survey, open-ended response field or other mechanism 325 provided via the outreach landing page), and/or provide promotions and/or links. The outreach landing page may function as a user interface for the consumer. In examples, the outreach landing page may be provided in both mobile and desktop versions, and provide for authentication via email and/or SMS (corresponding email addresses and/or phone numbers known for use with notification types 340 including email 342 or SMS 341). In an example, a consumer may only be able to submit a response to a prompt such as a survey or open-ended response field via the outreach landing page one time so as to prevent them from changing their feedback. Feedback from the outreach landing page may be provided to the AI analytics engine 360 as described by example herein.

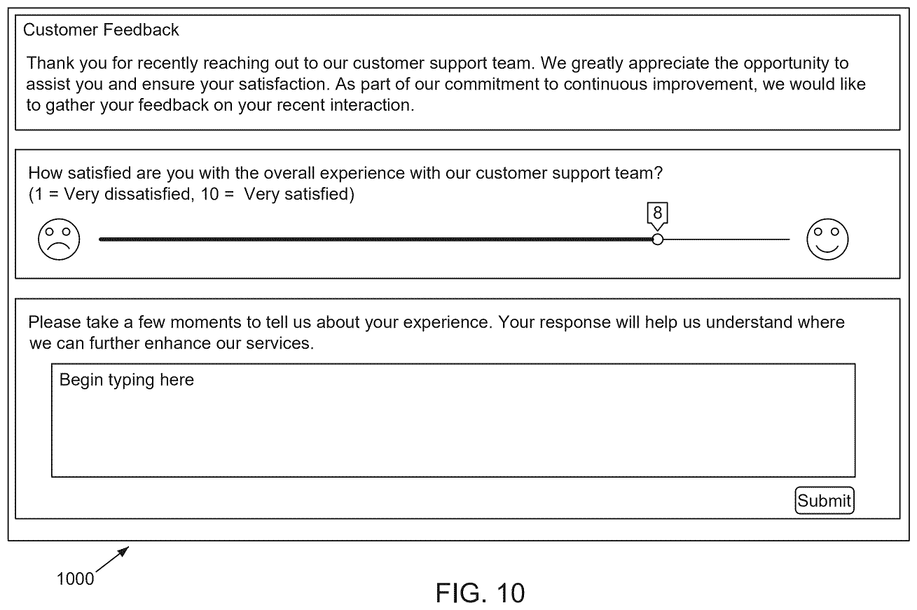

FIG. 10 illustrates an example outreach landing page 1000 according to an example embodiment. As described by example herein, in an embodiment, the outreach landing page 1000 may be provided to the consumer as a webpage linked from a notification. As illustrated in FIG. 10, the example outreach landing page 1000 includes an opportunity for the consumer to provide feedback including a satisfaction score ranging from very dissatisfied (1) to very satisfied (10), and an open-ended response field (e.g., text box) for the consumer to tell about their experience in an open-ended response field. In some examples, architecture 300 may provide audio transcription (e.g., from an omni-channel source 306) for the consumer to speak feedback for the text box. In some examples, the outreach landing page 1000 may include custom questions generated by, e.g., AI automation 320, based on the interaction, such as may be specific to that user's interaction with customer service.

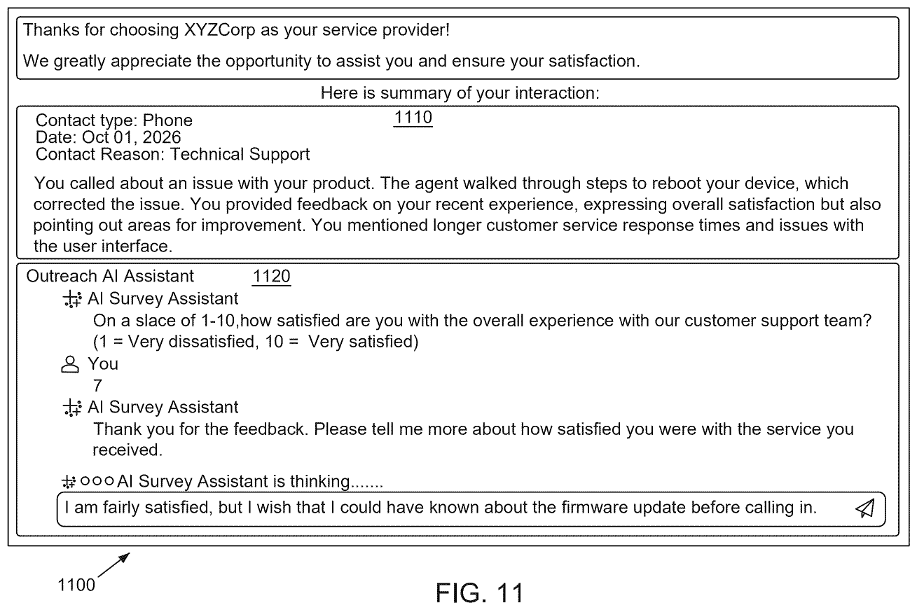

FIG. 11 illustrates an example outreach landing page 1100 according to an example embodiment. As illustrated in FIG. 11, the example outreach landing page 1100 may include a summary 1110 of the consumer's interaction with the organization (e.g., in the example, technical support provided by XYZCorp), as may be generated by text summarization 334 of the AI contact processing pipeline 330. Also, the example outreach landing page 1100 may include, as a mechanism 325, a chat bot 326 (which, in some examples, may include an AI agent) provided in the form of an “Outreach AI Assistant” 1120 that prompts the user with AI-generated questions and receives answers via an open-ended response field. In some examples, an “AI Survey Assistant” may help the customer complete the survey using an LLM (e.g., a GPT) and assisting the customer where needed.

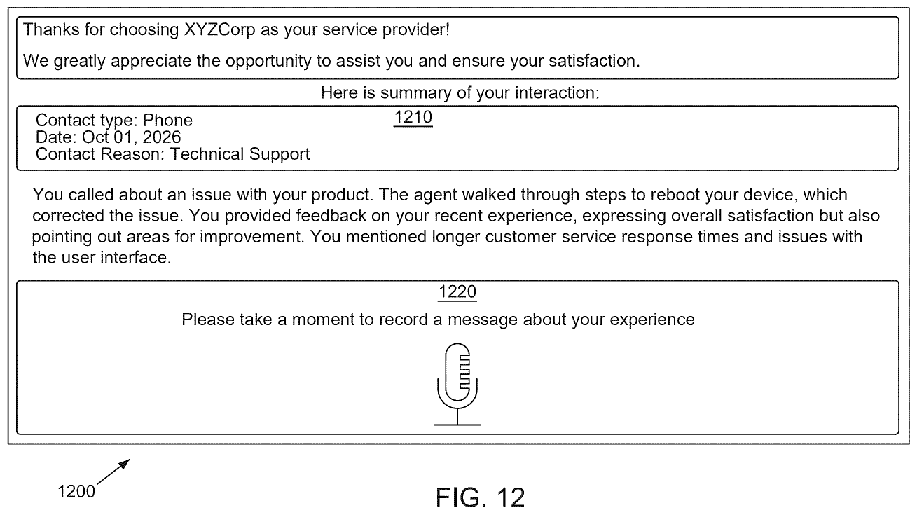

FIG. 12 illustrates an example outreach landing page 1200 according to an example embodiment. As illustrated in FIG. 12, the example outreach landing page 1200 may include a summary 1210 of the consumer's interaction with the organization (e.g., in the example, technical support), as may be generated by an automated summarization element 323 of AI automation 320 and/or text summarization 334 of the AI contact processing pipeline 330. Also, the example outreach landing page 1200 may include, as a mechanism 325, an example 1220 of an open recorded line 329 provided as a question to the user to “[p]lease take a moment to record a message about your experience.” In an example, this open recorded line 329 may be provided to the consumer automatically based on knowledge about the consumer's preferences and/or may be launched upon request by the consumer.

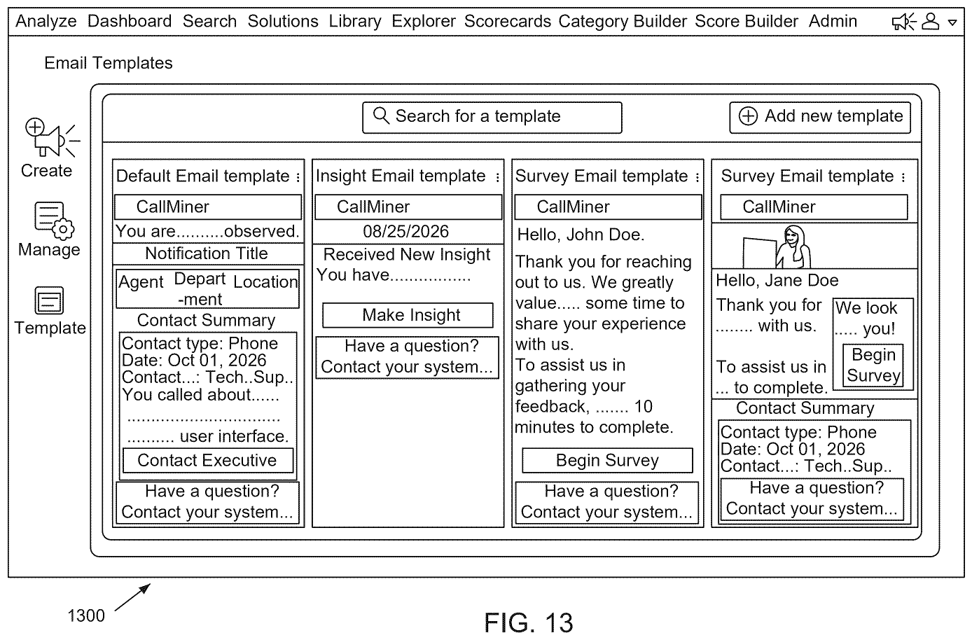

In example embodiments, and as seen in the example email template 1300 of FIG. 13, an administrator 305 may configure, e.g., via user interface 315, notifications and/or other outreach messages for various scenarios, such as notifications to provide the user with an outreach landing page discussed by example herein. For example, an administrator may be able to include contact summaries based on template options (which, in an example, may be generated by automated summarization 323 of AI automation 320), include hyperlinks (e.g., for an outreach landing page in the form of a webpage) and/or callback numbers (e.g., for an open recorded line 329). Additionally, the administrator may be able to set variables for the outreach messages, such as consumer name, company name, etc., and opt-out links for the consumer to opt out from receiving further outreach messages.

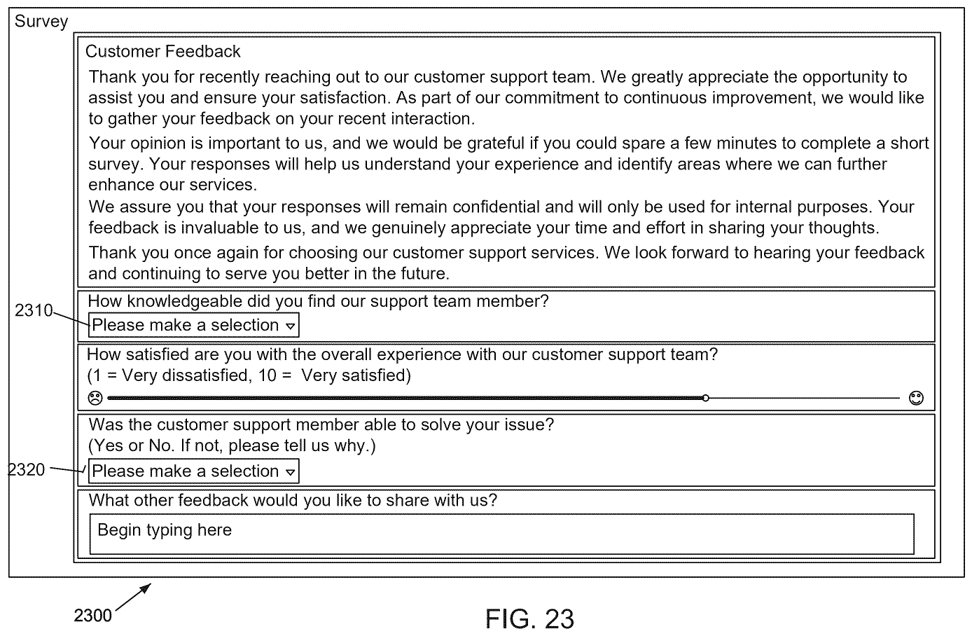

FIG. 23 illustrates an example outreach landing page 2300 according to an example embodiment. As shown in FIG. 23, the consumer may provide feedback including in the form of drop-down menus 2310 and 2320, which in an example, may include administrator-selected selections and/or AI-generated selections by the outreach engine architecture 300. In FIG. 23, upon the consumer selecting certain answers to a drop-down menu, the outreach landing page 2300 may expand with an open-ended response field for the consumer to provide the architecture 300 with more information. For example, only if the consumer selects “No” to the question “Was the customer support member able to solve your issue?” will the landing page 2300 expand to include an additional open-ended response field (e.g., text box) for the consumer to provide more details. Providing a constricted landing page that expands to include open-ended response fields where (e.g., only where) prompted by a consumer's answer, according to some example embodiments, may provide technical improvements to the field of graphical user interfaces by limiting the area of a screen occupied by the landing page and/or focusing the consumer's attention only on questions that the architecture 300 knows to be relevant to the consumer's experience. This constricted landing page, which may be less daunting to a consumer than seeing a full list of all possible questions and open-ended response fields, may also be more likely to encourage a consumer to complete the mechanism (e.g., survey). Indeed, once a consumer has started answering questions on the landing page, they may view answering the mechanism (e.g. survey) as a “sunk cost” and continue answering questions and/or filling in additional open-ended response fields until the survey is complete.

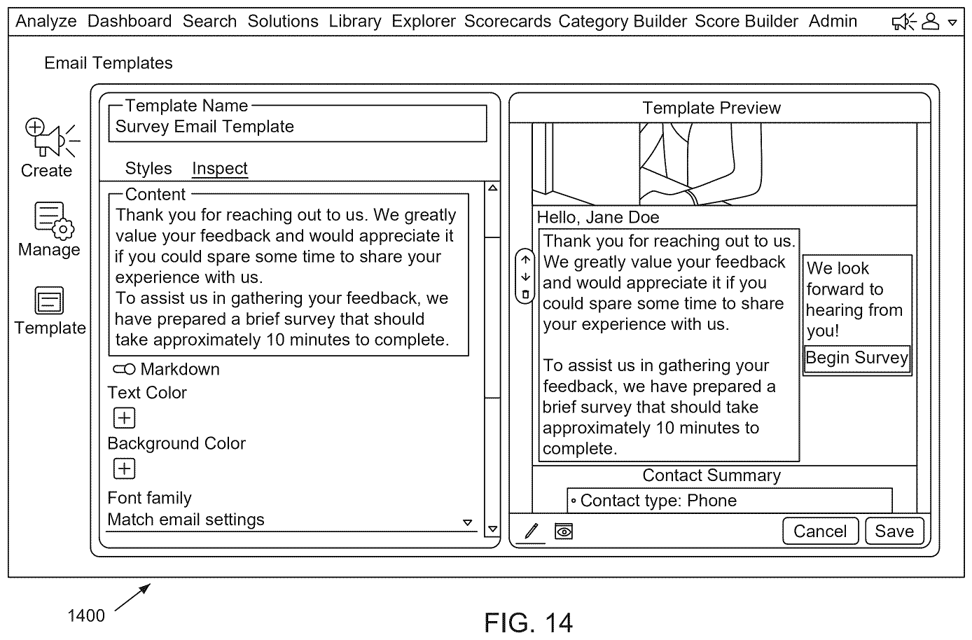

FIGS. 13 and 14 illustrate example email templates configurable by an administrator, e.g., via an administrator view 316. Such an email may be used as an email 342 notification type 340. As illustrated in the email template 1400 of FIG. 14, the email providing the notification (as shown by the “Template Preview”) may provide a link (i.e., “Begin Survey”) to an outreach mechanism 303 such as an outreach landing page. The administrator may be able to configure various aspects of a template, such as default content, markdown, text color, background color, font family (which may be set to match email settings), etc.

In example embodiments, outreach engine architecture 300 may be configured to ingest outreach information. For example, the outreach engine architecture 300 may ingest outreach responses per contact type. Outreach attempts (e.g., via notifications as discussed herein) may be tracked, regardless of whether a response is received, and responses to outreach may be used to fuel consumer journeys (e.g., through journey analysis and scoring 365) and shown in dashboards/reports 361 for the administrator, consumer, and/or other users. Outreach data may be stored in outreach store 375.

In example embodiments, outreach attempts (e.g., via notification types 340) may not occur due to retroprocessing, and new outreach attempts may not be based on consumer feedback (e.g., a survey response or other response from an outreach mechanism 303 including, e.g., a mechanism 325) unless specified by the architecture 300 (such as by an administrator). Thus, example embodiments may provide technical improvements by providing a closed loop 308 that avoids infinite feedback through continued surveys prompted by a consumer's responses to surveys. However, in example embodiments, notifications may still trigger based on survey responses, such as thanking the consumer for completing a survey or providing a promotion/giveaway 328 as a thank you.

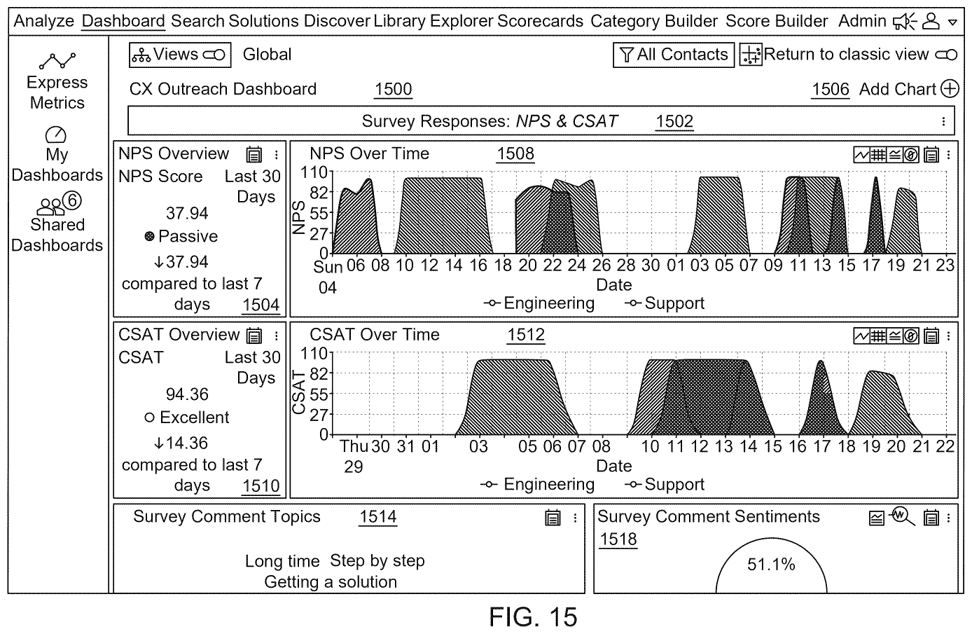

In example embodiments, dashboards/reports 361 may depict, e.g., on a user interface 315, outreach attempts, response rates, survey calculations (e.g., NPS, CSAT, CES, etc.), and/or demographic data, such as based on metadata. For example, FIG. 15 depicts an example dashboard 361 for presenting outreach scores 365 based on responses to surveys 327 (e.g., CX outreach dashboard 1500). The CX outreach dashboard 1500 is flexible, allowing users (e.g., an administrator) to add charts 1506 displaying certain information. For example, the CX outreach dashboard 1500 of this example is configured to depict aspects of survey responses 1502 relating to NPS and CSAT over time. Differing shades, patterns, and/or colors n the charts may differentiate between, e.g., “Engineering” and “Support” and show overlaps therebetween.

The NPS overview 1504 provides data regarding measures of customer loyalty over a pre-determined time span. In this example, the NPS overview 1504 is provided for a 30 day time period, but it should be understood that data for other time periods are readily accessible through the dashboard 1500. In this example, the NPS overview indicates a passive rating, which is a relatively neutral stance on if one or more customers were likely to recommend a product or service, and it also indicates a declining trend. The NPS over time chart 1508 depicts NPS ratings achieved by specific groups (engineering and support in this example) over a period of time. The dashboard 1500 also provides a view of CSAT, which measures customer satisfaction with a specific interaction or overall experience. In this example, the CSAT overview 1510 for a period of time indicates a score related to customer satisfaction over a time period, and a rating and a trend indication is also provided. The CSAT over time chart 1512 depicts CSAT for different groups of users. In this example, the CSAT over time chart 1512 is on a different scale than the NPS over time chart 1508, however, a person of skill in the art having the benefit of this disclosure will understand that dashboards 1500 are able to display data for various measures across the same time period, which may help users draw conclusions about CX. The dashboard 1500 may also depict survey comment topics 1514, such as in the form of a word cloud, excerpts, or other format. Topic processing & clustering 362 of the AI analytics engine 360, which may use the methods and systems disclosed in the 916 Publication, generates the survey comment topics 1514 for display. The dashboard 1500 may also present survey comment sentiment 1518, such as performed by sentiment 339 analysis of the AI contact processing pipeline 330. Sentiment 339 analysis may use methods and systems disclosed in one or more of the 891 Patent or the 916 Publication.

Outreach reporting and journey analytics includes enhanced scoring and trending, and provides the ability to score a customer's overall interaction with a company to predict Net Promoter Score (NPS), Churn Risk, etc. Customer interactions can be analyzed using advanced scoring and summarization in multiple ways: Customer Journey Scoring & Summarization (e.g., to provide a single score and summary of the entire path of a customer), Journey Path Analysis (e.g., to look at the most common paths a customer takes in their journey and comparing to other user profiles), or Contact Profile (e.g., to understand the DNA of a contact to determine what events lead to the best outcomes).

Customer Journey Scoring & Summarization allows for the creation of multiple journey types, such as by department, time frame, customer profile, etc. Grouped contacts from a journey can be saved as a single entity, and a “score of scores” can be obtained for scoring a journey. An example workflow includes: 1) User creates experience score for each contact; 2) Overall score for a contact is used as an indicator for new score; 3) New score is generated based on logic applied to all contacts in a journey. A summary of events at the journey level can be generated, which can be done by using summaries from each contact to generate a single overall summary of the customer journey.

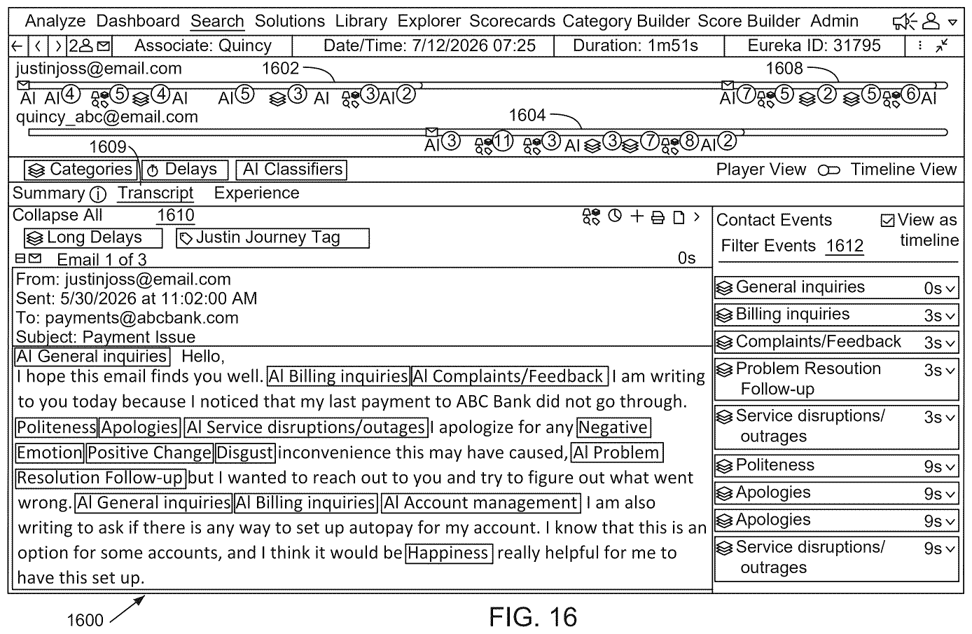

Referring now to FIG. 16, an administrator view 316 of a user interface 315 that allows journey analysis and scoring 365 of material from multiple sources 306 is depicted in the example search interface 1600. In example embodiments, the user interface 315 represents a technical improvement in the field of customer interaction tracking by visually displaying contact events in the form of a timeline, simplifying the task of understanding the intent and sentiment involved in the communication while being able to drill down into a single contact and see precisely which part of the communication resulted in a particular contact event.

An example contact/journey is presented in the search screen with data regarding the contact presented in the longitudinal email views 1602, 1604, 1608 representing a chronological traversal through the contact (e.g., journey). In the contact, an email from justinjoss@email.com is shown as longitudinal email view 1602, followed by a reply from quincy_abc@email.com as shown in longitudinal email view 1604, and a follow-up email from justinjoss@email.com is shown as longitudinal email view 1608. In each of the longitudinal views, the AI analytics engine 310 adds a tag related to events associated with one or more triggers 336, such as text classification 337, scoring 338, or sentiment 339, or output thereof. The view shown in FIG. 16 is a transcript 1609 view and shows the transcript 1610 of the emails, and a Summary and Experience screen can also be accessed through the example search interface 1600. A transcript 1610 of the email shown in longitudinal email view 1602 is presented with various tags associated with categories, sentiments, and classifications dispersed through the text of the email. Contact events 1612 provides a summary of the tagged events found in the email.

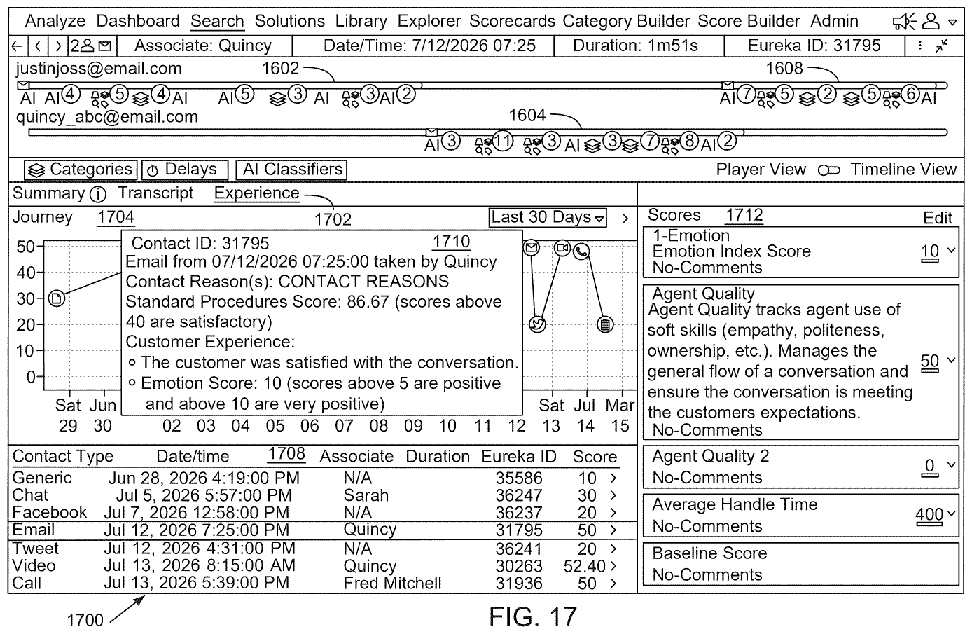

Continuing with the example seen in FIG. 16, and with reference now to the example user interface 1700 of FIG. 17, the experience view 1702 has been selected, which shows output from the journey analysis & scoring 365. The contact journey is depicted both in a graph 1704 and in a table 1708 form with data including contact type, date/time, associate, duration, system identifier, score, and the like. When an icon representing a contact is selected in the graph 1704 form of the journey, a dialogue box 1710 appears with relevant data and the contact is highlighted in the table. In this example, the contact data shown in the dialogue box includes agent name, contact id, contact type, date/time, contact reason, standard procedures score, customer experience information (e.g., sentiment, satisfaction, emotion score). The journey view can be set to show any time period. A scores 1712 panel can be seen indicating scores associated with the selected contact, such as emotion score, agent quality score, average handle time score, baseline score, and the like. Customer outreach responses are considered part of the journey.

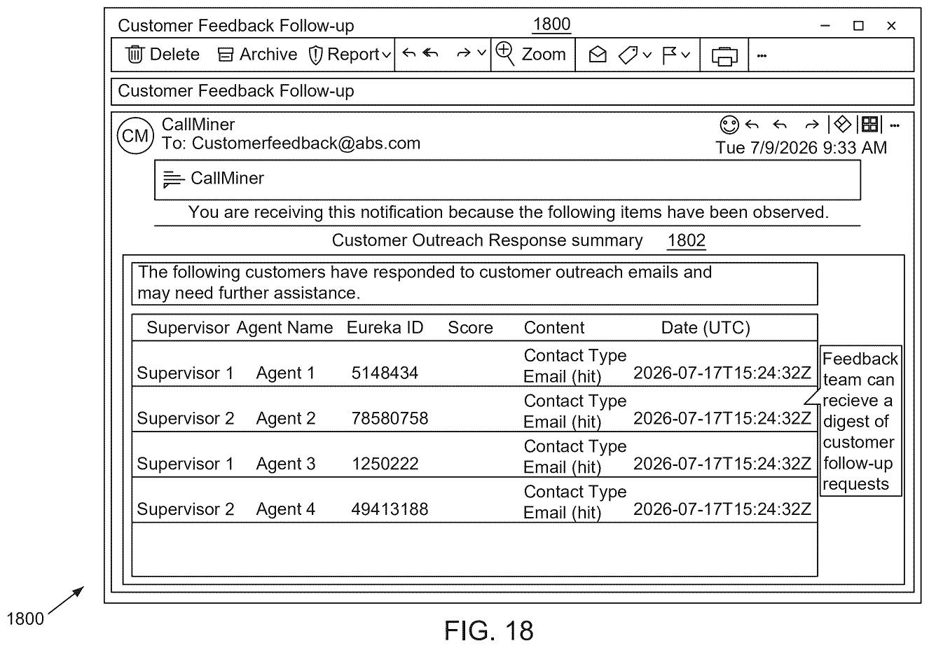

Using the sorts of data displayed in the examples of FIG. 16 and FIG. 17, the architecture 300 enables improved customer feedback follow-up. By ingesting the data from multiple interactions, summarizing it, and performing analysis of the interactions, the task of following up with customers is improved by the architecture's 300 ability to recommend and automate actions based on the data. For example, FIG. 18 illustrates an example graphical user interface 1800 (e.g., displayed to an administrator, such as via a user interface 315) displaying an email 342 delivered to the administrator with an internal notification 363. In this example email, a customer outreach response summary 1802 is shown with a listing of customers who have responded to customer outreach emails and may need further assistance. The listing may include information such as supervisor ID, agent name, system identifier, score, content (e.g., contact type), date/time, and the like.

In example embodiments, the architecture 300 may analyze various data points regarding a specific user (referred to herein as a consumer or customer), such as email address, phone numbers, social media handles, gender, age bracket, location, etc. Metadata fields may be reserved for CX use cases. Customer profiles may be built by consumer profiling 364 using various data points regarding the user, as may be obtained from omni-channel sources 306 through AI contact processing pipeline 330, learned from responses to outreach mechanisms 303, or through other inputs. For example, in some embodiments, data for customer profiles may be obtained in partnership with other organizations. In some examples, any opt-out settings may be honored even if customer data changes.

In example embodiments, a customer profile (also referred to herein as a user profile or consumer profile) may be a collection of personal data associated with a specific user, as may be accumulated from data points as described by example herein. Customer profiles may be used to identify customers and to tailor user experiences according to individual preferences, behavior, and characteristics. In some examples, a consumer profile may include one or more of the following: Personal Information: Basic details such as name, age, gender, and contact information; Preferences and Interests: User preferences related to content, products, services, and interaction styles; Behavioral Data: Information on how a user interacts with the company, including survey responsiveness, purchases, and contact frequency; History and Activity: Records of past interactions, transactions, and engagements within the application or service; Settings and Configurations: Custom settings the user has chosen, such as notification preferences, privacy settings, and display preferences; Authentication Information: Credentials like usernames, passwords, and security questions used for identity verification; and/or Demographic Information: Broader details like location, occupation, and education level, often used for targeted services and marketing.

In example embodiments, as has been described by example herein, the architecture 300 (e.g., survey 327 element) may generate an AI survey. For example, the architecture 300 may provide an NPS, CSAT, CES, etc., survey, which in an example may be powered by generative pre-trained transformer (GPT) prompts, which may include a large language model. In examples, the survey 327, including prompts generated therefor, may be based on, e.g., interactions between the consumer (e.g., in the form of a report), as may be digested by the AI contact processing pipeline 330. And in examples, such interactions may include the at least one category or score as described by example herein.

In some examples, survey creation (e.g., in conjunction with an administrator) may include, e.g., on a page displayed by a user interface 315, question generation (e.g., multiple choice, multi-select, comment box, etc.), follow-up requirements, and/or out-of-the-box (OOTB) survey templates (e.g., NPS, CSAT, CES), and/or pre-build components. Notifications (e.g., those of notification type 340) may be able to link to surveys such as AI surveys. A survey landing page may be provided as an outreach mechanism 303 and may be made available through e.g., a link in a notification with a one-time login. The survey landing page may provide a consumer with the ability to answer the survey. Upon completion of a survey, the architecture 300 (e.g., AI analytics engine 30) may automatically ingest the consumer's response to the survey as discussed by example herein.

In some examples, administrators or other users may be able to set notification priorities (e.g., which notification to send if more than one is available) and/or survey joining (making the survey longer). Additionally, administrators or other users may be able to set time frames, for example via the scheduling type 345 element, such as: having an “active period” for when to send a notification (when to send/deactivate); scheduling an occurrence notification (delay in sending); cool off periods (no notifications after one has been sent); removing these notifications from firing on retroprocessing; no surveys of survey responses (no infinite loops, keeping a closed loop 308); and/or “random” survey with a set chance of sending. Some examples may include permitting a third party to ingest a survey response.

In some examples, the architecture 300 may provide an administrator with the ability to generate survey questions using AI (e.g., text prompts), or for the AI itself to generate such survey questions automatically based on user data (including, for example, consumer interactions as described by example herein, such as the at least one category or score). The same or similar may apply to a chat bot, which may function as an outreach mechanism 303 in place of or in addition to surveys and other feedback mechanisms, and which ask questions to the consumer in real time.

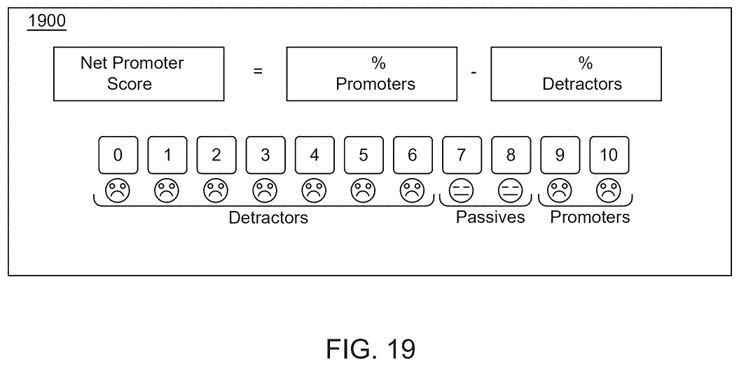

Referring now to FIG. 19, in example embodiments, Net Promoter Score (NPS) 1900 is a metric that measures how likely customers are to recommend a company, product, or service. NPS is measured on a scale of 0 to 10, with ten being the highest rank. An example question that may be used in a survey to determine the NPS 1900 is: “On a scale of 0 to 10, how likely are you to recommend this company's product or service to a friend or colleague?”. In an example, NPS is calculated by taking the percentage of customers who are promoters (score of 9 or 10) minus the percentage who are detractors (score of 0 to 6).

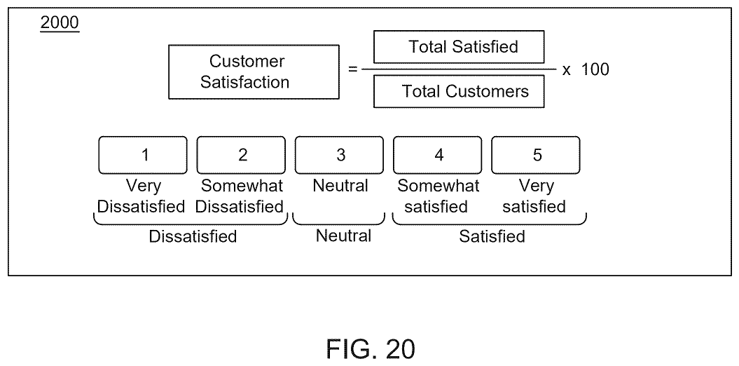

Referring to FIG. 20, in example embodiments, Customer Satisfaction (CSAT) 2000 is a metric that measures the satisfaction for a particular product, transaction, interaction, and/or service. CSAT 2000 is measured on a scale of 1 to 10, 1 to 7, or 1 to 5, with the lowest end being “very unsatisfied” and the higher end is “very satisfied”. An example question that may be used in a survey to determine the CSAT 2000 is: “On a scale of 1 to 5, how satisfied are you with the service you received?”. CSAT 2000 is calculated by taking the number of customers who are satisfied (score of 4 or 5) divided by the total number of customers, then multiplied by 100.

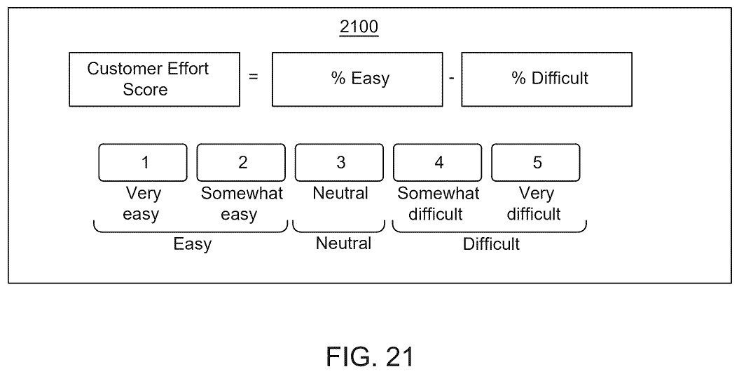

Referring to FIG. 21, in example embodiments, Customer Effort Score (CES) 2100 is a metric that measures how much effort a customer has put in to complete a specific interaction with a company. CES 2100 is typically measured on a scale of 1 to 10 or 1 to 5, with one end being “very low effort” and the other end as “very high effort”. An example question that may be used in a survey to determine the CES 2100 is: “How easy was it to solve your problem today?”. CES 2100 is calculated by taking the percentage of easy experiences minus the percentage of difficult experiences.

In example embodiments, the outreach engine architecture 300, such as the AI analytics engine 360, may provide enhanced scoring and trending, such as scoring a customer's overall interaction with an organization (e.g., a company) to predict NPS, churn risk, etc. Such functions may be provided by journey analysis and scoring 365. For example, example embodiments may provide, e.g., a single score and summary of the entire path of a customer in the form of customer journey scoring and summarization. Also, example embodiments may provide a journey path analysis, which looks at the most common paths a customer takes in their journey and compares it to other user profiles. Additionally, example embodiments may provide a contact profile, which provides understanding a contact to determine what events lead to the best outcomes.

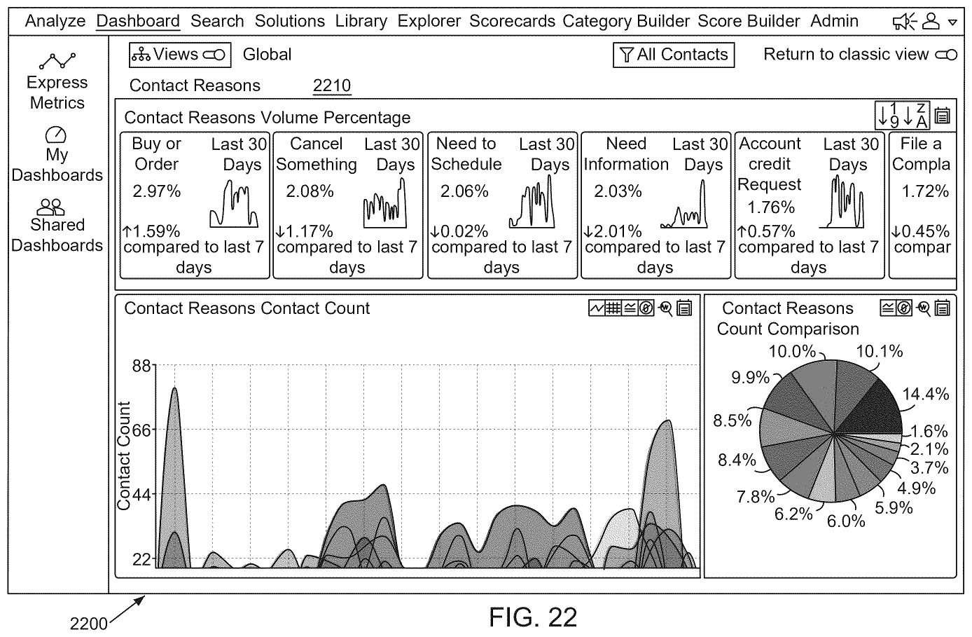

With reference to the example dashboard 2200 depicted in FIG. 22, in example embodiments, the AI analytics engine 360 (e.g., dashboards/reports 361) may provide, e.g., via a user interface 315, a contact reasons 2210 interface including contact reasons per volume percentage. For example, in FIGS. 22, 2.08% of the contacts were to “cancel something.”

In example embodiments, customer journey scoring and summarization (e.g., as provided by AI analytics engine 360) may provide a single score and summary of the entire path of a customer. Additionally, example embodiments may allow the creation of multiple journey types—for example, by department, time frame, customer profile, etc. Group contacts from a journey may be saved as a single entity. A “score of scores” may be provided for scoring a journey. In a workflow, a user may create an experience score for each contact. An overall score for a contact may be used as an indicator for a new score. And the new score may be generated based on logic applied to all contacts in a journey.

A summary of events at the journey level may be generated. Summaries from each contact may be used to generate a single overall summary of the customer journey.

In example embodiments, users such as feedback specialists may be given tools specific to following up on customer complaints across multiple channels.

In an example use case of systems and methods according to example embodiments (e.g., using the outreach engine architecture 300 described by example herein), a customer experience executive may want to send messages to consumers so that they can improve the customer experience. Thus, in this example, if the consumer had a bad experience (which may be determined in accordance with example embodiments described herein, including an interaction, survey, reports thereto, and/or the at least one category or score), example systems and methods may send an SMS message with a link to a gift card. As another example, a customer service analyst may want to send surveys to customers to gather data about their experience, and example systems and methods may prepare such a survey. As another example, a feedback specialist may want a list of survey responses to reach out to consumers as appropriate for follow-up. For example, did the technician fix the customer's service during their truck roll? If not, a feedback specialist will call the consumer back to close the loop. As another example, a consumer may want an easy way to understand their recent interaction so that they know the next steps in their journey. Thus, the consumer landing page may include an AI summary with follow-up actions for the consumer.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

As described herein, machine learning models may be trained using supervised learning or unsupervised learning. In supervised learning, a model is generated using a set of labeled examples, where each example has corresponding target label(s). In unsupervised learning, the model is generated using unlabeled examples. The collection of examples constructs a dataset, usually referred to as a training dataset. During training, a model is generated using this training data to learn the relationship between examples in the dataset. The training process may include various phases such as: data collection, preprocessing, feature extraction, model training, model evaluation, and model fine-tuning. The data collection phase may include collecting a representative dataset, typically from multiple users, that covers the range of possible scenarios and positions. The preprocessing phase may include cleaning and preparing the examples in the dataset and may include filtering, normalization, and segmentation. The feature extraction phase may include extracting relevant features from examples to capture relevant information for the task. The model training phase may include training a machine learning model on the preprocessed and feature-extracted data. Models may include support vector machines (SVMs), artificial neural networks (ANNs), decision trees, and the like for supervised learning, or autoencoders, Hopfield, restricted Boltzmann machine (RBM), deep belief, Generative Adversarial Networks (GAN), or other networks, or clustering for unsupervised learning. The model evaluation phase may include evaluating the performance of the trained model on a separate validation dataset to ensure that it generalizes well to new and unseen examples. The model fine-tuning may include refining a model by adjusting its parameters, changing the features used, or using a different machine-learning algorithm, based on the results of the evaluation. The process may be iterated until the performance of the model on the validation dataset is satisfactory and the trained model can then be used to make predictions.

In embodiments, trained models may be periodically fine-tuned for specific user groups, applications, and/or tasks. Fine-tuning of an existing model may improve the performance of the model for an application while avoiding completely retraining the model for the application.

In embodiments, fine-tuning a machine learning model may involve adjusting its hyperparameters or architecture to improve its performance for a particular user group or application. The process of fine-tuning may be performed after initial training and evaluation of the model, and it can involve one or more hyperparameter tuning and architectural methods.

Hyperparameter tuning includes adjusting the values of the model's hyperparameters, such as learning rate, regularization strength, or the number of hidden units. This can be done using methods such as grid search, random search, or Bayesian optimization. Architecture modification may include modifying the structure of the model, such as adding or removing layers, changing the activation functions, or altering the connections between neurons, to improve its performance.

Online training of machine learning models includes a process of updating the model as new examples become available, allowing it to adapt to changes in the data distribution over time. In online training, the model is trained incrementally as new data becomes available, allowing it to adapt to changes in the data distribution over time. Online training can also be useful for user groups that have changing usage habits of the stimulation device, allowing the models to be updated in almost real-time.

In embodiments, online training may include adaptive filtering. In adaptive filtering, a machine learning model is trained online to learn the underlying structure of the new examples and remove noise or artifacts from the examples.

All references, including publications, patent applications, and patents, cited herein are hereby incorporated by reference to the same extent as if each reference were individually and specifically indicated to be incorporated by reference and were set forth in its entirety herein.

Preferred aspects of the embodiments are described herein, including the best mode known to the inventors for carrying out the embodiments described herein. Variations of those preferred aspects may become apparent to those of ordinary skill in the art upon reading the foregoing description. The inventors expect a person having ordinary skill in the art to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While the embodiments have been illustrated and described in detail in the foregoing drawings and description, the same is to be considered as illustrative and not restrictive in character, it being understood that only illustrative embodiments thereof have been shown and described and that all changes and modifications that come within the spirit of the disclosure are desired to be protected. For example, any of the features or functions of any of the embodiments disclosed herein may be incorporated into any of the other embodiments disclosed herein.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

In addition to the features described above and elsewhere herein, the present disclosure also includes the following clauses:
Clause 1. A method, comprising: receiving a record of an interaction between an agent and a human user in the interaction; analyzing the record to generate at least one characteristic of the interaction attributable to the human user, wherein the at least one characteristic comprises: a non-word symbol, a period of silence, a language characteristic, or an acoustic aspect; determining at least one category or score for at least a portion of the interaction based on the at least one characteristic; generating a summary of the interaction using a machine learning model; and generating a customized communication based on the at least one category or score, wherein the customized communication includes the summary and at least one prompt for the human user.
Clause 2. The method of clause 1, wherein the at least one characteristic additionally comprises at least one of a topic or metadata.
Clause 3. The method of clause 1, further comprising, transmitting the customized communication to the human user.
Clause 4. The method of clause 1, wherein the agent is an automated agent.
Clause 5. The method of clause 1, wherein the agent is a human agent.
Clause 6. The method of clause 1, wherein the machine learning model is at least one of an extractive machine learning summarization model or an abstractive machine learning summarization model.
Clause 7. The method of clause 1, wherein the at least one category is selected from the group consisting of a behavior, a sentiment, a reason, a procedure, a competitor, a dissatisfaction, an empathy, a repeat contact, a transferred call and a politeness.
Clause 8. The method of clause 1, wherein the at least one prompt is at least one of a survey or an open-ended response field.
Clause 9. The method of clause 1, wherein the customized communication further comprises at least one of an offer, a delivery of resources or information, a coupon, a call, or other customized customer engagement.
Clause 10. The method of clause 8, wherein the survey is at least one of a Net Promoter Score (NPS) survey, a Customer Satisfaction Score (CSAT) survey, a Customer Effort Score (CES) survey, open-ended including voice/text/symbols, multiple choice, multi-select, an IVR survey, a market research survey, a market segmentation survey, a brand perception surveys, a product feedback survey, an employee satisfaction survey, an event feedback survey, or a website/user experience (UX) survey.
Clause 11. The method of clause 8, wherein the interaction is at least one of a social media interaction, a review post, an IVR, a chat, an email, audio, a call, a voicemail, a message, a blog post, a survey, a video conferences, an online meeting, or a webinar.
Clause 12. The method of clause 8, wherein the score is an interaction score.
Clause 13. The method of clause 12, wherein the interaction score is further based on at least one acoustic, prosodic, syntactic, or visual feature of the interaction.
Clause 14. The method of clause 6, wherein the abstractive machine learning summarization model is trained based on long form summarization.
Clause 15. The method of clause 6, wherein the abstractive machine learning summarization model is trained based on chunked/bucketed summarization.
Clause 16. The method of clause 6, wherein the abstractive machine learning summarization model is trained based on an interaction summary label/short sentence.
Clause 17. The method of clause 6, wherein the extractive machine learning summarization model is configured through training to identify at least one word or phrase from the record, the at least one word or phrase corresponding to the summary of the interaction.
Clause 18. The method of clause 17, wherein the training is based on supervised learning for two-class labels.
Clause 19. The method of clause 18, wherein a first label is for summary content and a second label is for non-summary content.
Clause 20. The method of clause 8, wherein the at least one prompt is at least partially populated, wherein populating the at least one prompt comprises: populating at least one input field of the at least one prompt with answers corresponding to a question associated with the at least one input field using a form filling model, wherein the form filling model is configured through training to identify an answer to the question associated with the at least one input field from at least one of the record of the interaction or the interaction summary.
Clause 21. The method of clause 20, wherein the form filling model comprises a plurality of models with at least one model for each question associated with an input field of the at least one prompt.
Clause 22. The method of clause 20, wherein the form filling model is based on a clustering algorithm, and each input field is represented by at least one cluster.
Clause 23. The method of clause 22, wherein the form filling model identifies the answer by clustering content from the record.
Clause 24. The method of clause 23, wherein the form filling model identifies the answer by further determining the at least one input field for the content based on a cluster of the content.
Clause 25. The method of clause 20, wherein the form filling model is a natural language processing (NLP) model.
Clause 26. The method of clause 8, further comprising, performing analytics on a text or recognized voice/spoken words in the open-ended response field.
Clause 27. The method of clause 26, wherein the analytics includes determining at least one category or score based on a content of the open-ended response, the content including at least one of written text, audio speech, non-word symbols, metadata, silences, language characteristics, or acoustic characteristics.
Clause 28. The method of clause 8, further comprising, applying one or more rules to a delivery including at least one of delivering the customized communication by a specified delivery type, restricting delivery to a timeframe, restricting delivery by a frequency, restricting delivery to a number of identified consumers per a time period, or restricting delivery in response to an event, factor, or other data.
Clause 29. The method of clause 8, further comprising restricting at least one of the at least partially customizing the customized communication or delivery in accordance with one or more rules.
Clause 30. The method of clause 29, wherein the one or more rules includes restricting subsequent communication of a survey when the interaction was a survey.
Clause 31. The method of clause 29, wherein the one or more rules includes restricting a communication when the interaction occurred more than a past predetermined time.
Clause 32. The method of clause 29, wherein the one or more rules includes prioritizing delivery of a communication from a plurality of generated communications based on an aspect of the interaction, user data, metadata, or customer journey data.
Clause 33. The method of clause 29, wherein the one or more rules includes combining one or more communications from a plurality of generated communications based on an aspect of the interaction, user data, metadata, or customer journey data.
Clause 34. The method of clause 1, further comprising including the customized communication and any responses to the customized communication in a customer journey, wherein the customer journey includes linking one or more communications on at least one communication channel of a plurality of communication channels to the human user.
Clause 35. The method of clause 1, wherein at least one of the record, the at least one characteristic, the at least one category or score, the summary, the customized communication, one or more responses to the customized communication, analytics on the one or more responses to the customized communication, or the at least one category or score based on the one or more responses to the customized communication are selectable from an outreach dashboard user interface (UI), the outreach dashboard UI depicting interactions over time.
Clause 36. The method of clause 35, wherein the outreach dashboard UI further depicts survey content topics and sentiments that get consolidated into a journey view, outreach attempts, response rates, survey calculations, demographic data, or user data.
Clause 37. The method of clause 2, wherein the metadata includes one or more of email address, phone numbers, contact information, social media handles, gender, age bracket, name, or location.
Clause 38. The method of clause 36, wherein the user data includes one or more of preferences and interests.
Clause 39. The method of clause 36, wherein the user data includes one or more of behavioral data, settings and configurations, authentication information, or demographic information.
Clause 40. The method of clause 1, further comprising, redacting the record before generating the summary of the interaction.
Clause 41. The method of clause 1, further comprising, enriching the summary of the interaction with metadata.
Clause 42. A method, comprising: receiving a record of an interaction between an agent and a human participant in the interaction while the interaction is ongoing; analyzing the record to generate at least one characteristic of the interaction attributable to the human participant, wherein the at least one characteristic comprises: a topic, a non-word symbol, metadata, a period of silence, a language characteristic, or an acoustic aspect; determining at least one category or score for at least a portion of the interaction based on the at least one characteristic; generating a summary of the interaction using a machine learning model; generating, based on the at least one category or score, survey questions about the interaction; and administering the survey questions to the human participant while the interaction is ongoing.
Clause 43. The method of clause 42, further comprising: recording answers from the human participant to the survey questions; and generating a summary of the interaction and responses to the survey questions.
Clause 44. The method of clause 42, wherein the administering is via a same channel as the interaction.
Clause 45. The method of clause 42, wherein the administering is via a different channel as the interaction.
Clause 46. The method of clause 42, wherein the agent is an automated agent.
Clause 47. The method of clause 42, wherein the agent is a human agent.
Clause 48. The method of clause 42, wherein the machine learning model is at least one of an extractive machine learning summarization model or an abstractive machine learning summarization model.
Clause 49. The method of clause 42, wherein the at least one category is selected from the group consisting of a behavior, a sentiment, a reason, a procedure, a competitor, a dissatisfaction, an empathy, a repeat contact, a transferred call and a politeness.
Clause 50. The method of clause 42, wherein the survey questions are part of at least one of a Net Promoter Score (NPS) survey, a Customer Satisfaction Score (CSAT) survey, a Customer Effort Score (CES) survey, open-ended including voice/text/symbols, multiple choice, multi-select, an IVR survey, a market research survey, a market segmentation survey, a brand perception surveys, a product feedback survey, an employee satisfaction survey, an event feedback survey, or a website/user experience (UX) survey.
Clause 51. The method of clause 42, wherein the interaction is at least one of a social media interaction, a review post, an IVR, a chat, an email, audio, a call, a voicemail, a message, a blog post, a survey, a video conferences, an online meeting, or a webinar.
Clause 52. The method of clause 42, wherein the score is an interaction score.
Clause 53. The method of clause 52, wherein the interaction score is further based on at least one acoustic, prosodic, syntactic, or visual feature of the interaction.
Clause 54. The method of clause 48, wherein the abstractive machine learning summarization model is trained based on long form summarization.
Clause 55. The method of clause 48, wherein the abstractive machine learning summarization model is trained based on chunked/bucketed summarization.
Clause 56. The method of clause 48, wherein the abstractive machine learning summarization model is trained based on an interaction summary label/short sentence.
Clause 57. The method of clause 48, wherein the extractive machine learning summarization model is configured through training to identify at least one word or phrase from the record, the at least one word or phrase corresponding to the summary of the interaction.
Clause 58. The method of clause 57, wherein the training is based on supervised learning for two-class labels.
Clause 59. The method of clause 58, wherein a first label is for summary content and a second label is for non-summary content.
Clause 60. The method of clause 42, further comprising including responses to the survey questions in a customer journey, wherein the customer journey includes linking one or more communications on at least one communication channel of a plurality of communication channels to the customer.
Clause 61. The method of clause 42, wherein at least one of the record, the at least one characteristic, the at least one category or score, the summary, the survey questions, one or more responses to the survey questions, analytics on the one or more responses to the survey questions, or the at least one category or score based on the one or more responses to the survey questions are selectable from an outreach dashboard user interface (UI), the outreach dashboard UI depicting interactions over time.
Clause 62. The method of clause 61, wherein the outreach dashboard UI further depicts survey content topics and sentiments that get consolidated into a journey view, outreach attempts, response rates, survey calculations, demographic data, or user data.
Clause 63. The method of clause 62, wherein the metadata includes one or more of email address, phone numbers, contact information, social media handles, gender, age bracket, name, or location.
Clause 64. The method of clause 62, wherein the user data includes one or more of preferences and interests.
Clause 65. The method of clause 62, wherein the user data includes one or more of behavioral data, settings and configurations, authentication information, or demographic information.
Clause 66. The method of clause 42, further comprising, redacting the record before generating the summary of the interaction.
Clause 67. The method of clause 42, further comprising, enriching the summary of the interaction with metadata.
Clause 68. The method of clause 42, further comprising, performing analytics on a text or recognized voice/spoken words in response to the survey questions.
Clause 69. The method of clause 68, wherein the analytics includes determining at least one category or score based on a content of the response, the content including at least one of written text, audio speech, non-word symbols, metadata, silences, language characteristics, or acoustic characteristics.

1. A method, comprising:
receiving a record of an interaction between an agent and a human user in the interaction;
analyzing the record to generate at least one characteristic of the interaction attributable to the human user, wherein the at least one characteristic comprises: a non-word symbol, a period of silence, a language characteristic, or an acoustic aspect;
determining at least one category or score for at least a portion of the interaction based on the at least one characteristic;
generating a summary of the interaction using a machine learning model; and
generating a customized communication based on the at least one category or score, wherein the customized communication includes the summary and at least one prompt for the human user.

2. The method of claim 1, wherein the at least one characteristic additionally comprises at least one of a topic or metadata.

3. The method of claim 1, further comprising, transmitting the customized communication to the human user.

4. The method of claim 1, wherein the agent is an automated agent.

5. The method of claim 1, wherein the agent is a human agent.

6. The method of claim 1, wherein the machine learning model is at least one of an extractive machine learning summarization model or an abstractive machine learning summarization model.

7. The method of claim 1, wherein the at least one category is selected from the group consisting of a behavior, a sentiment, a reason, a procedure, a competitor, a dissatisfaction, an empathy, a repeat contact, a transferred call and a politeness.

8. The method of claim 1, wherein the at least one prompt is at least one of a survey or an open-ended response field.

9. The method of claim 1, wherein the customized communication further comprises at least one of an offer, a delivery of resources or information, a coupon, a call, or other customized customer engagement.

10-33. (canceled)

34. The method of claim 1, further comprising including the customized communication and any responses to the customized communication in a customer journey, wherein the customer journey includes linking one or more communications on at least one communication channel of a plurality of communication channels to the human user.

35. The method of claim 1, wherein at least one of the record, the at least one characteristic, the at least one category or score, the summary, the customized communication, one or more responses to the customized communication, analytics on the one or more responses to the customized communication, or the at least one category or score based on the one or more responses to the customized communication are selectable from an outreach dashboard user interface (UI), the outreach dashboard UI depicting interactions over time.

36-39. (canceled)

40. The method of claim 1, further comprising, redacting the record before generating the summary of the interaction.

41. The method of claim 1, further comprising, enriching the summary of the interaction with metadata.

42. A method, comprising:
receiving a record of an interaction between an agent and a human participant in the interaction while the interaction is ongoing;
analyzing the record to generate at least one characteristic of the interaction attributable to the human participant, wherein the at least one characteristic comprises: a topic, a non-word symbol, metadata, a period of silence, a language characteristic, or an acoustic aspect;
determining at least one category or score for at least a portion of the interaction based on the at least one characteristic;
generating a summary of the interaction using a machine learning model;
generating, based on the at least one category or score, survey questions about the interaction; and
administering the survey questions to the human participant while the interaction is ongoing.

43. The method of claim 42, further comprising:
recording answers from the human participant to the survey questions; and
generating a summary of the interaction and responses to the survey questions.

44-59. (canceled)

60. The method of claim 42, further comprising including responses to the survey questions in a customer journey, wherein the customer journey includes linking one or more communications on at least one communication channel of a plurality of communication channels to the customer.

61. The method of claim 42, wherein at least one of the record, the at least one characteristic, the at least one category or score, the summary, the survey questions, one or more responses to the survey questions, analytics on the one or more responses to the survey questions, or the at least one category or score based on the one or more responses to the survey questions are selectable from an outreach dashboard user interface (UI), the outreach dashboard UI depicting interactions over time.

62-65. (canceled)

66. The method of claim 42, further comprising, redacting the record before generating the summary of the interaction.

67. The method of claim 42, further comprising, enriching the summary of the interaction with metadata.

68. The method of claim 42, further comprising, performing analytics on a text or recognized voice/spoken words in response to the survey questions.

69. (canceled)
